(19) United States
(12) Patent Application Publication
(10) Pub. No.: US 2012/0267005 A1
(43) Pub. Date: Oct. 25, 2012

(54) Filling Device for Use With a Container

(76) Inventors: Stephen Alan Smith, Naperville, IL (US); Timothy Joseph Backe, Chicago, IL (US); James A. Hubbard, JR., Oak Lawn, IL (US)

(21) Appl. No.: 13/090,404

(22) Filed: Apr. 20, 2011

(51) Int. Cl. B67C 11/04

(52) U.S. Cl. 141/331

(57) ABSTRACT

A filling device directs a flow of a substance into a container. The filling device includes a bowl, a spout connected with the bowl, and a pusher. The pusher is connected with the spout to extend below the spout. The pusher has rounded bottom corner edges and is configured to move an inner lining away from an opening of the container without tearing the inner lining when the filling device is inserted in the opening.

### TECHNICAL FIELD

The present description relates generally to a filling device, and more specifically relates to a filling device for use with a container.

### BACKGROUND

Consumers frequently purchase ready-made coffee, and other beverages, in large, bulk beverage containers, such as for an office, a party, or for catering. A user may fill the container by pouring a beverage through an opening in the container into an inner lining. Pouring liquids through a container opening may be complicated and inefficient. For example, the inner lining of the bulk beverage container may be deflated, creating resistance to the efficient flow of liquids. The user may have to frequently pause to allow a beverage to pass into the container. Pouring a liquid too quickly may cause the liquid to overflow. In some situations, this may create a burn hazard where the beverage is hot.

### SUMMARY

A filling device directs a flow of a substance into a container. The filling device includes a bowl, a spout connected with the bowl, and a pusher. The pusher is connected with the spout to extend below the spout. The pusher has rounded bottom corner edges and is configured to move an inner lining away from an opening of the container without tearing the inner lining when the filling device is inserted in the opening.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a perspective view of a filling device and a container.

FIG. 2 is a perspective view of a filling device.

FIG. 3 is a perspective view of a filling device.

FIG. 4a is a perspective view of a filling device.

FIG. 4b is a cross-sectional perspective view of a filling device.

FIG. 5a is a side view of a filling device.

FIG. 5b is a cross-sectional perspective view of a filling device.

FIG. 6 is a front view of a filling device.

FIG. 7 is a top view of a filling device.

FIG. 8 is a bottom view of a filling device.

FIG. 9 is a cross-sectional side view of a filling device and container.

FIG. 10 is a cross-sectional side view of a filling device and container.

FIG. 11 is a side view of two filling devices in a stacked configuration.

FIG. 12a is an elevated perspective view of a filling device.

FIG. 12b is a cross-sectional top perspective view of a filling device.

FIG. 13 is a cross-sectional side view of a filling device.

FIG. 14 is a top view of a filling device.

FIG. 15 is a bottom view of a filling device.

FIG. 16a is a side perspective view of a filling device.

FIG. 16b is a cross-sectional side perspective view of a filling device.

FIG. 17a is a side view of a filling device.

FIG. 17b is a cross-sectional side view of a filling device.

FIG. 18 is a top view of a filling device.

FIG. 19 is a bottom view of a filling device.

FIG. 20 is a front view of a filling device.

FIG. 21 is a top perspective view of a filling device.

FIG. 22 is a cross-sectional side view of a filling device.

FIG. 23 is a top view of a filling device.

FIG. 24 is a bottom view of a filling device.

FIG. 25 is a side perspective view of a filling device.

FIG. 26 is a side view of a filling device.

FIG. 27 is a cross-sectional side view of a filling device.

### DETAILED DESCRIPTION

A filling device, such as a funnel, may be used to provide rapid filling of a container. Users and/or vendors may find that efficient and/or rapid container filling may expedite service or use. Users and/or customers may find that expedited service saves time and resources.

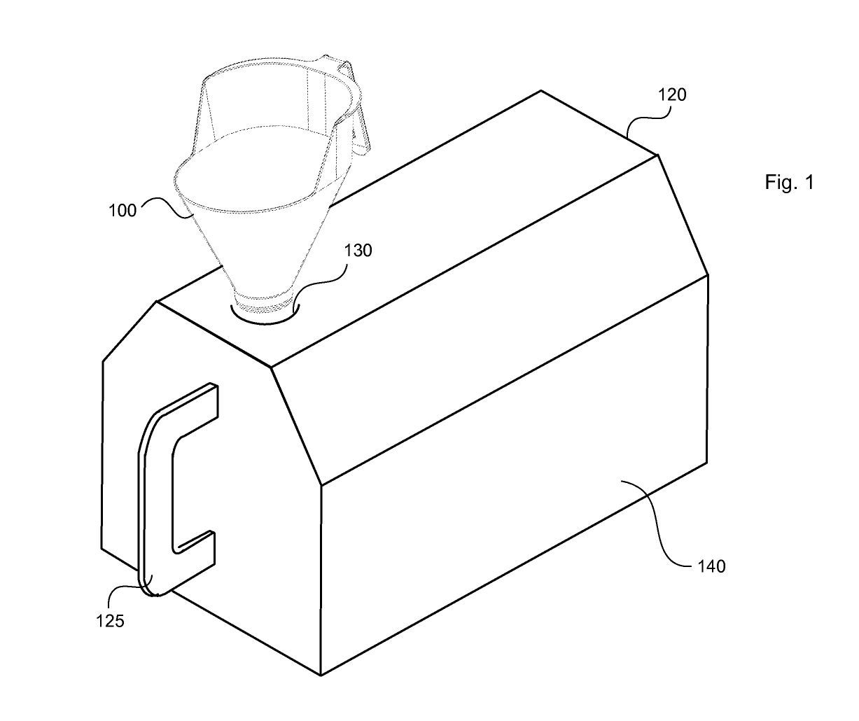

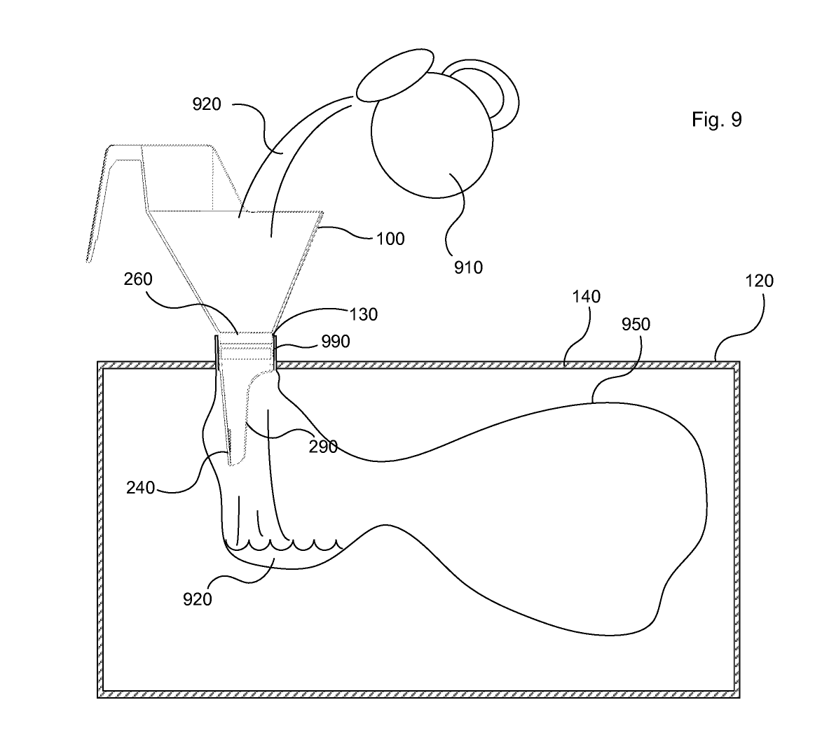

FIG. 1 illustrates a filling device 100 which may be used with a container 120. A container 120 may, for example, be a bulk beverage container or various other containers. The container 120 may, for example, have an opening 130, an outer shell 140, and an inner lining (such as inner lining 950 shown in FIG. 9 and discussed below). The inner lining 950 may include, be accessible from, and/or connected with the opening 130, such that a substance poured through the opening 130 may enter the inner lining 950 of the container 120. For example, as shown in FIG. 9 and described below, an inner lining 950 may include a fitment 990, which may protrude through an outer shell 140 of a container 120, and/or may reside snugly next to and/or represent the opening 130. Other configurations are possible.

The filling device 100 may be used during rapid pouring of substances, such as beverages, liquids, and/or other fluids, through the opening 130 of the container 120. The filling device 100 may permit an establishment to rapidly, efficiently, and conveniently fill a container 120.

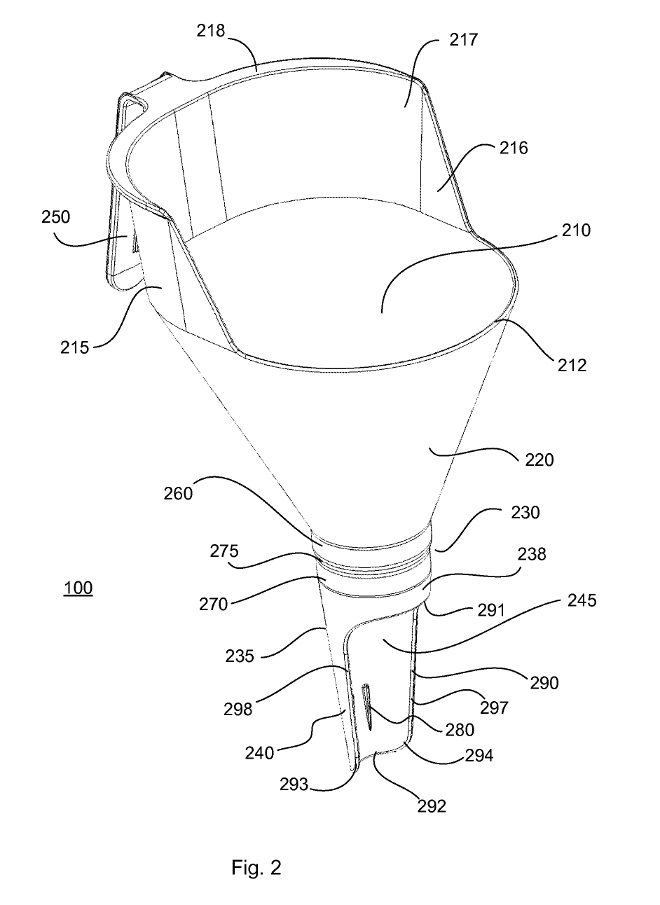

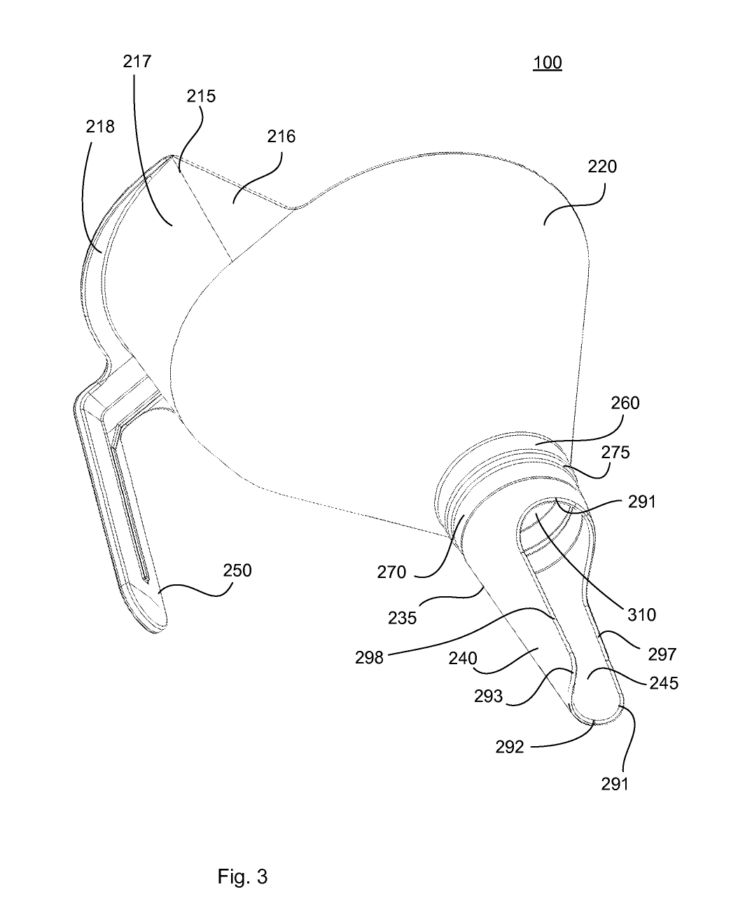

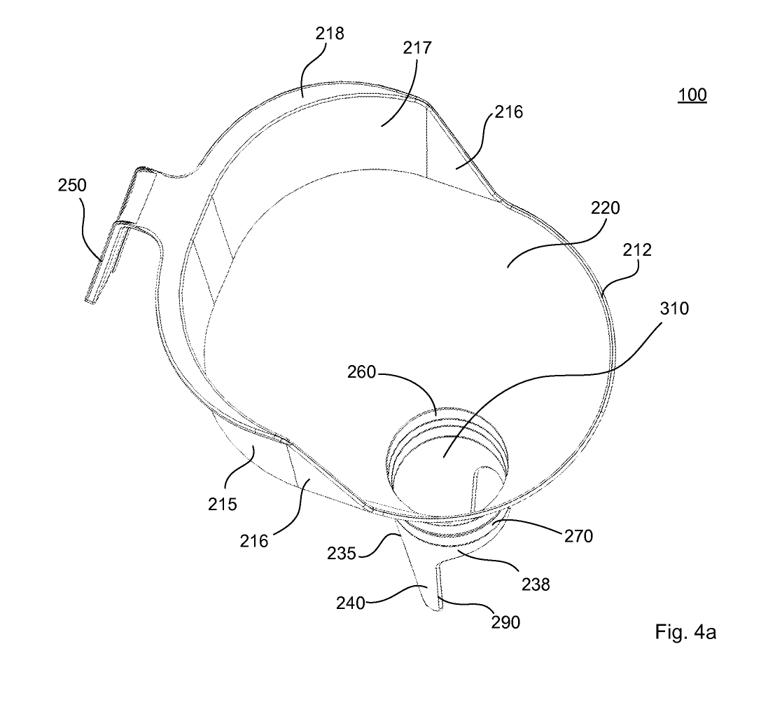

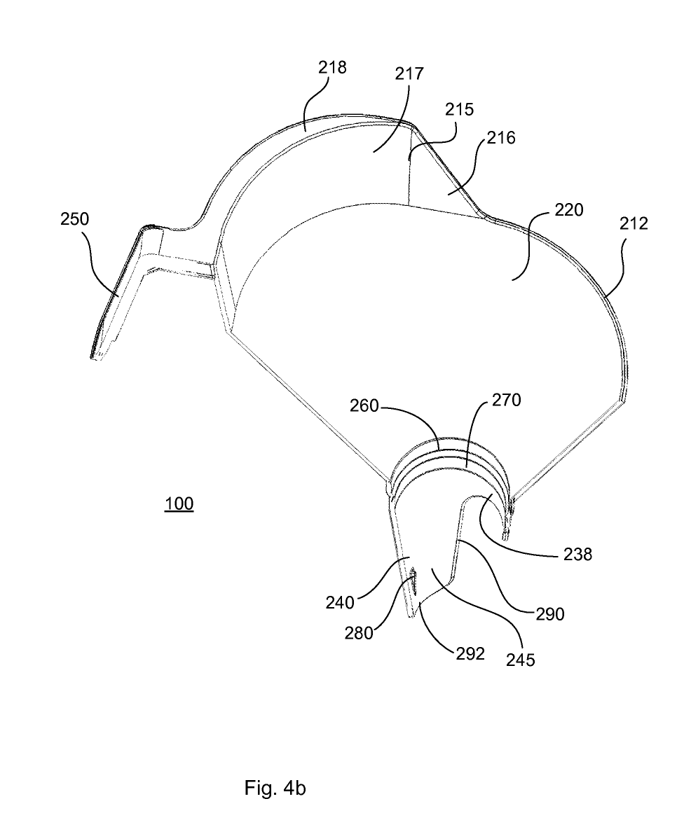

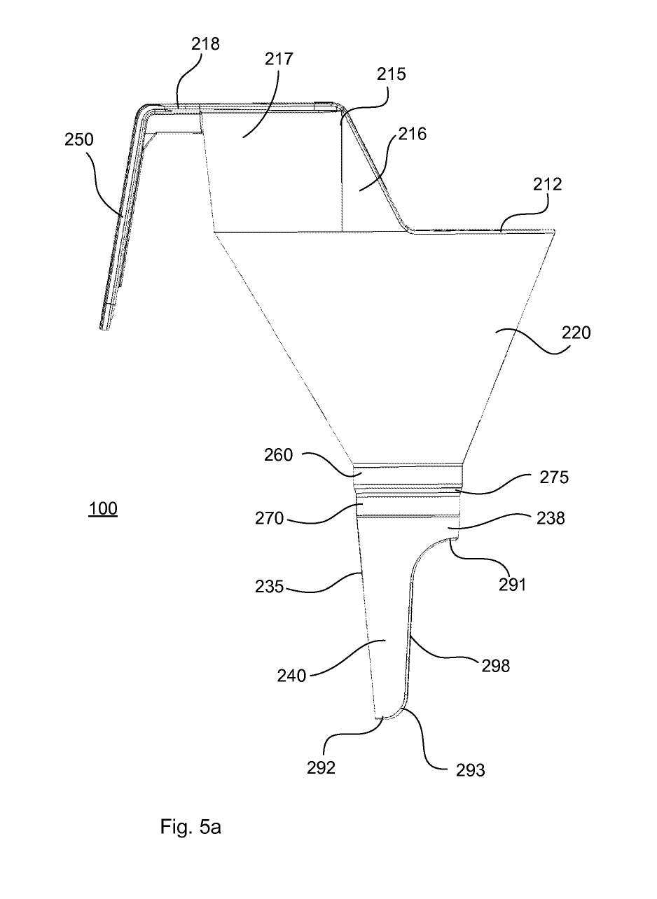

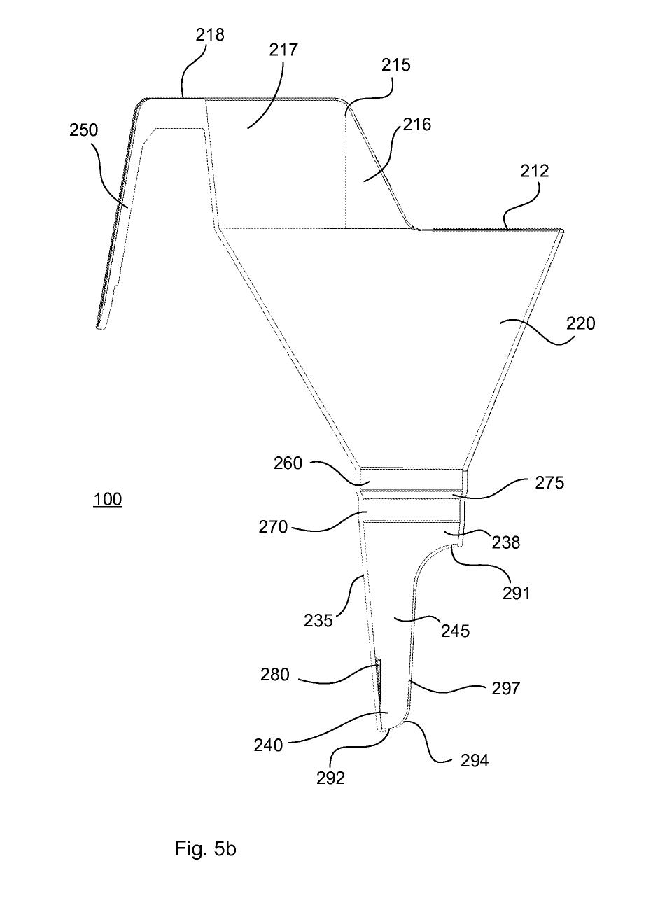

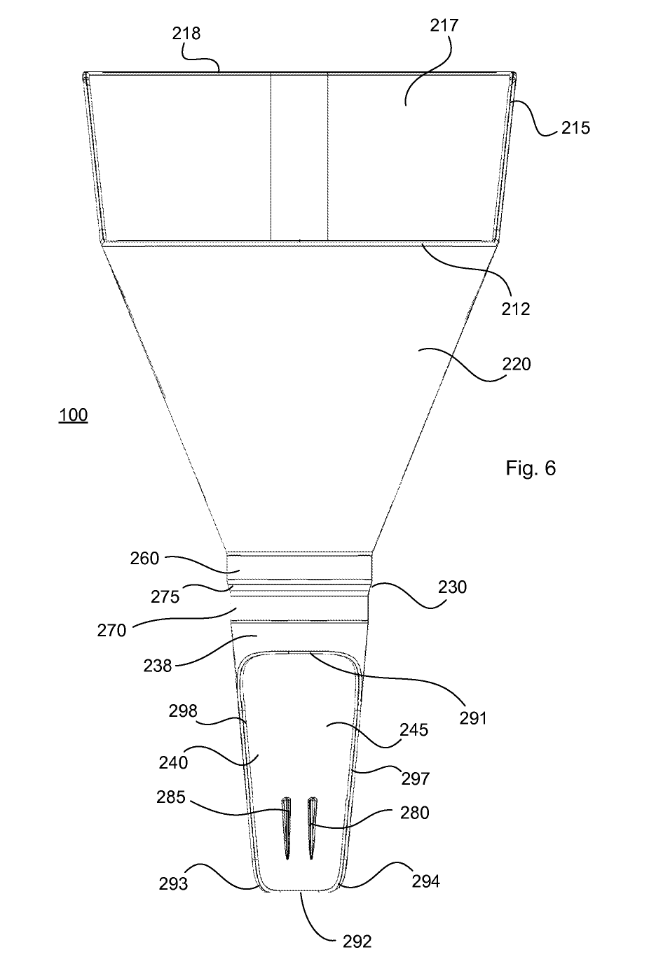

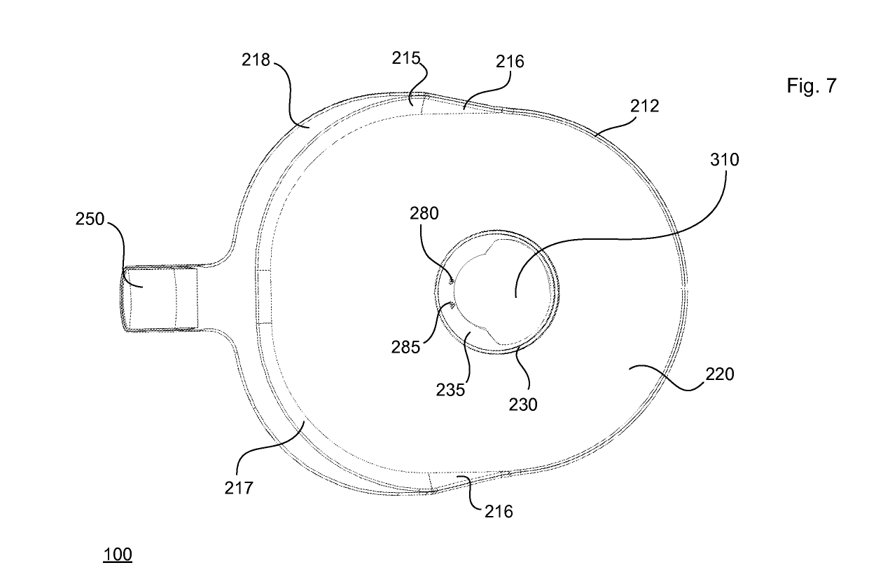

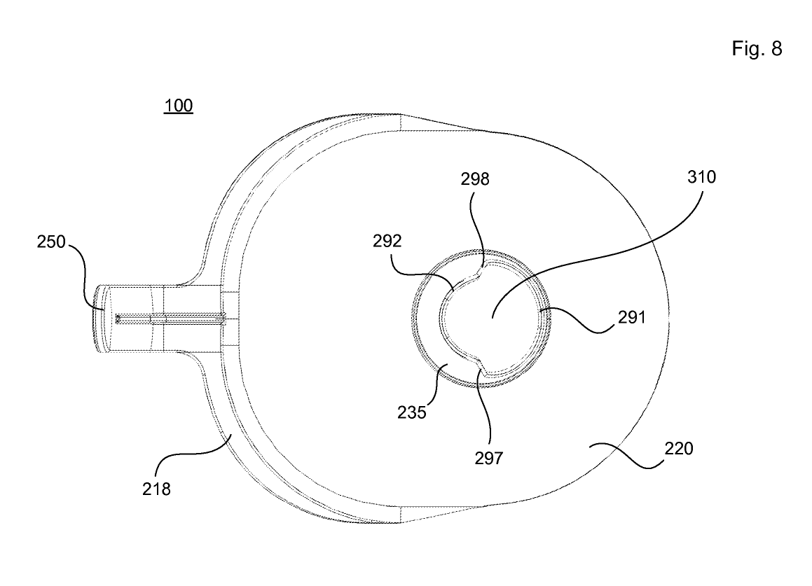

FIG. 2 shows an elevated front-side perspective view of a filling device 100. FIG. 3 shows a bottom-side perspective view of the filling device 100. FIG. 4a shows a top-side perspective view of the filling device 100. FIG. 4b shows a cross-sectional top-side perspective view of the filling device 100 shown in FIG. 4a. FIG. 5a shows a side view of the filling device 100. FIG. 5b shows a cross-sectional side view of the filling device 100 shown in FIG. 5a. FIG. 6 shows a front view of the filling device 100. FIG. 7 shows a top view of the filling device 100. FIG. 8 shows a bottom view of the filling device 100.

The filling device 100 may be made of and/or formed from various materials, such as, for example polyethylene, ABS, styrene, paper, glass, hard formable materials, moldable materials, rubber, metal, fiber, polypropylene, other plastics, combinations of these materials, and/or various other materials or combinations of materials. The filling device 100 may be created using injection molded processes, or formed in various other ways. Materials used in creating the filling device 100 may be clear or may include fillers and/or colorants. For example, some filling devices 100 may be made of and/or include polypropylene, and may or may not include 40% calcium carbonate filler. Various other configurations are possible.

The filling device 100 may include one or more of a guard 215, a bowl 220, a joining component 230 with one or more fitment engaging members 260 and 270, a spout 235, a pusher 240, and/or a handle 250. More or less components may be included with the filling device 100. Substances, such as a beverage, liquid and/or other fluid, may be poured into the filling device 100, such as through the top opening 210, and may exit the filling device 100, such as through a bottom opening 310 and/or the spout 235.

The bowl 220 of the filling device 100 may be various shapes. For example, the bowl 220 may be frusto-conical, frusto-pyramidal, frusto-spherical, funnel-shaped, tapered, and/or various other shapes or combinations of shapes. In some systems, the bowl 220 may resemble a frusto-conical shape, except that the bowl 220 may have an oval, oblong, or obloid cross-sectional shape instead of a circular cross-sectional shape along part or all of the bowl 220. The bowl 220 may appear and/or function as a funnel One or more sides of the bowl 220 may be curved and/or rounded. In other configurations, one or more sides of the bowl may be flat or planar. Other shapes and configurations are possible.

The bowl 220 may have one or more openings. For example, the bowl 220 may have a top opening 210, which may be at the top of the bowl 220. An upper or top edge 212 of the bowl 220 may bound and/or identify the top opening 210. The top edge 212 of the bowl 220 may create, identify, and/or lie in a top plane of the bowl 220. The top opening 210 may be various shapes and/or sizes. For example, the top opening 210 may be oblong shaped, and may have a length of 4 inches and a width of 3.8 inches. Alternatively, the top opening 210 may be circular, rounded, square, triangular, rectangular, oval, and/or various other shapes, and may have various other dimensions, such as a length less than or greater than 4 inches, and/or a width less than or greater than 3.8 inches. Various shapes and sizes are possible.

The top opening 210 may, for example, be where a substance such as a beverage or a liquid may be poured or otherwise deposited into the filling device 100.

The bowl 220 may have a bottom opening, such as bottom opening 310. Bottom opening 310 may be positioned opposite the top opening 210 or may be positioned in another part of the bowl 220. In some systems, a lower or bottom edge of the bowl 220 may bound and/or identify the bottom opening 310. The bottom edge of the bowl 220 may create, identify, and/or lie a bottom plane of the bowl 220. The bottom plane of the bowl 220 may or may not be parallel to the top plane of the bowl 220. The bottom opening 310 may be various shapes and/or sizes. For example, the bottom opening 310 may be circular, and may have a diameter of approximately 1.3 inches. Alternatively, the bottom opening 310 may be oval shaped, rounded, square, triangular, rectangular, oblong, and/or various other shapes, and may have various other dimensions, such as a diameter greater than 1.3 inches or less than 1.3 inches. Various sizes and/or shapes are possible.

The top opening 210 may be the same shape as the bottom opening 310, or the two openings may be different shapes. For example, in some systems, the bowl 220 may have a top opening 210 which may be oblong shaped, and a bottom opening 310 which may be circular. Other configurations and combinations are possible.

A height of the bowl 220 may be determined in various ways. For example, the height may be a distance measured from a center of the top opening 210 to a center of the bottom opening 310. The height may be a distance between the top plane identified by the top edge 212 of the bowl 220 and the bottom plane identified by the bottom edge of the bowl 220. Other ways of measuring a height are possible. The bowl 220 may be 2.75 inches high as measured taking the distance between the planes of the top edge and the bottom edge of the bowl 220. Other heights, such as greater than 2.75 inches or less than 2.75 inches, are possible.

One or more side walls of the bowl 220 may be curved and/or rounded. The one or more side walls of the bowl 220 may be angled relative to an axis of the bowl 220. For example, in a system with a top opening 210 having a greater area than a bottom opening 310, the one or more side walls of the bowl may be angled and/or taper, so that a substance entering the bowl 220 through the larger top opening 210 may be funneled and/or directed toward the smaller bottom opening 310. Various other configurations are possible.

The filling device 100 may have a guard 215 which may be attached to, connected with, and/or formed with the bowl 220. For example, part or all of the guard 215 may be attached to, connected with, and/or formed with part of the top edge 212 of the bowl 220. A portion of the top edge 212 of the bowl 220 may be exposed and not be attached to, connected with, and/or formed with the guard 215. Other attachments, connections, and formations may be possible.

The guard 215 may surround a portion of the top opening 210 of the bowl 220. The guard 215 may add a height to a portion of the filling device 100 where the guard 215 surrounds the top opening 210.

The guard 215 may include a ramp panel 216, a constant panel 217, and/or a lip 218. The guard 215 may have more or less features. The ramp panel 216 and/or the constant panel 217 may be attached to, connected with, and/or formed with the top edge 212 of the bowl 220. The lip 218 may be attached to, connected with, formed with, and/or positioned on top of a top edge of the ramp panel 216 and/or the constant panel 217.

The constant panel 217 may be a curved or rounded wall, such as half of a frustum of a cone or a semi-cylinder. The constant panel 217 may extend along part of the top edge 212 of the bowl 220. For example, the constant panel 217 may extend along approximately a third or a half of the top edge 212 of the bowl 220. In other systems, the constant panel 217 may extend along a greater or smaller part of the top edge 212 of the bowl 220. In some systems where the top edge 212 of the bowl 220 is oval shaped, the constant panel 217 may extend along half of the top edge 212 of the bowl 220 and be positioned and/or centered at a point on the top edge 212 of the bowl 220 corresponding to the major axis of the top edge 212 of the bowl 220. Other positions, configurations, and/or dimensions are possible.

The constant panel 217 of the guard 215 may have a substantially constant height, as measured from the top edge 212 of the bowl 220 to the lip 218. For example, the constant panel 217 of the guard 215 may have a height of 1.5 inches, or may have a height greater 1.5 inches or less than 1.5 inches. A lip 218 attached to a top of the constant panel 217 may be flat or planar, and may create, identify, and/or lie in a plane parallel to the top edge 212 of the bowl 220. Various heights and configurations are possible.

The constant panel 217 may be angled relative to a line perpendicular to the plane formed by the top edge 212 of the bowl 220. A side of the constant panel 217 may not be perfectly vertical when the filing device 100 is positioned vertically in a container 120. In systems where the constant panel 217 is angled, the filling device 100 may be better suited and/or capable of stacking and/or nesting with another filling device. In other systems, the constant panel 217 may be perfectly vertical when the filling device 100 is positioned vertically in a container 120, such that the constant panel 217 may resemble a portion of a cylinder. Various other shapes and configurations are possible.

One or more ramp panels 216 may be included with the guard 215. A ramp panel 216 may be or resemble a curved or rounded triangular panel. A height of a ramp panel 216 may transition a height of the guard 215 from the constant height of the guard 215 along the constant panel 217 to a zero height at an edge of the guard 215 which meets an exposed top edge 212 of the bowl 220. For example, a ramp panel 216 may extend from an end of the constant panel 217 a distance along an adjacent top edge 212 of the bowl 220. The ramp panel 216 may have a height which constantly increases or decrease across the distance along the top edge 212 of the bowl 220. One ramp panel 216 may exist on each side of the constant panel 217.

The guard 215 may begin at one part of the top edge 212 of the bowl 220, may smoothly increase in height through the ramp panel 216 until the constant panel 217 of the guard 215 is reached, may maintain the height of the constant panel 217 throughout a distance along the top edge 212 of the bowl 220, and then may smoothly decrease in height through a second ramp panel 216 after the constant panel 217 until the guard 215 ends and transitions into the exposed portion of the top edge 212 of the bowl 220. In this way, the ramp panel 216 may allow for a gradual transition from the top edge 212 of the bowl 220 to the lip 218 on top of the constant panel 217.

The lip 218 may extend along a top edge of the constant panel 217 of the guard 215. The lip 218 may be flat, or may be various other shapes. The lip 218 may be approximately 0.25 inches wide at any point, and/or may be various other sizes. The width of the lip 218 may remain constant or may change. The lip 218 may be flat and/or planar, and/or may be parallel to a top edge 212 of the bowl 220. Various other shapes and configurations are possible.

In some systems, the guard 215 may have more or less components. For example, in some systems, the guard 215 may not have a lip 218. In other systems, no ramp panel 216 may be included. In other systems, the guard 215 may have two ramp panels 216 next to each other, and no constant panel 217. In still other systems, the filling device 100 may not have a guard 215. Various other configurations are possible.

The guard 215 may act as a splash guard, and/or may prevent a substance, such as a beverage that may slosh around and/or move within the bowl 220 during pouring, from spilling or falling out of a top side of the bowl 220. The guard 215 may prevent an overflow during pouring of a beverage.

The guard 215 may indicate and/or be used to identify a target for a user or vender pouring a substance such as a beverage into the filling device 100. For example, a user may note the location of the guard 215 and/or may aim when pouring for a side of the bowl 220 which resides and/or is positioned below the guard 215. A user or vendor may pour a substance, such as coffee from a coffee pot, into the filling device 100. During the pouring, the coffee from the coffee pot may have a horizontal displacement due to the nature of the pouring, as well as a vertical displacement due to gravity. The guard 215 may indicate which direction to pour the coffee and/or identify a target to the user for pouring, so that user may pour the coffee towards a portion of the filling device 100 with the extra height and/or splash protection provided by the guard 215. For example, the user may direct a horizontal displacement of the coffee from the coffee pot toward a point of the filling device aligned with a central point of the guard 215. In this way, the liquid poured by the user may contact the filling device 100 along a portion of the bowl 220 with additional height and support provided by the guard 215.

In some systems, the lip 218 of the guard 215 may be flat and/or planar, and/or may be parallel to a top edge 212 of the bowl 220. In some systems, the lip 218 of the guard 215 may extend around more than half of the top edge 212 of the bowl 220. In other systems, a central axis of the filling device 100 and/or a center of gravity of the filling device 100 may be shifted backward toward the handle 250. In either of these systems, the filling device 100 may be turned upside down and rested on the flap lip 218. In these systems, additional filling devices 100 may be stacked with the filling device 100, all of which may rest on a lip 218 of one of the filling devices 100. In these systems, the filling devices 100 may not tip over when resting on the lip 218. These systems may prove advantageous in storing multiple filling devices 100 stacked or nested together. In other systems, the filling device 100 may not rest on top of the lip 218.

The filling device 100 may include a joining component 230. The joining component 230 may be attached to, connected with, and/or formed with the bowl 220. For example, the joining component 230 may be attached to, connected with, and/or formed with a bottom edge of the bowl 220, such as an edge of the bowl 220 surrounding the bottom opening 310. Various other configurations are possible.

The joining component 230 may be used to secure the filling device 100 with the container 120. For example, the joining component 230 may be created and/or formed so that a portion or all of the joining component 230 may fit snugly in the opening 130 of the container 120. The joining component 230 may provide a transition between the bowl 220 and the spout 235. The joining component 230 may provide support and/or increased strength to the filling device 100. The joining component 230 may be used for fitting the filling device 100 with an opening 130 of the container 120.

The joining component 230 may include one or more of a top fitment engaging member 260, a bottom fitment engaging member 270, and a transition component 275. The fitment engaging member may also be referred to as a fitting ring, a cooperative sealing ring, a sealing ring, a location ring, a cooperative locator, a locator, a fitting member, a cooperative member, a sealing member, a locator member, a fitting component, a cooperative component, a sealing component, and/or a locator component.

The top fitment engaging member 260 may be various shapes, such as cylindrical, ring-shaped, frusto-conical, and/or other shapes. The top fitment engaging member 260 may be hollow and/or may have a hole in it to allow a liquid to flow through it. The top fitment engaging member 260 may have various dimensions. For example, where the top fitment engaging member 260 is cylindrical, the top fitment engaging member 260 may have a height of approximately 0.25 inches, and a diameter of 1.27 inches. In other systems, the top fitment engaging member 260 may have a height greater than 0.25 inches or less than 0.25 inches, and/or may have a diameter of greater than 1.27 inches or less than 1.27 inches.

The top fitment engaging member 260 may bound and/or create or identify one or more openings and/or a channel. For example, where the top fitment engaging member 260 is cylindrical, a channel may be formed inside cylindrical top fitment engaging member 260. In some systems, a cross-sectional shape of the top fitment engaging member 260 may be the same or a similar shape as the opening 130 of the container 120, the fitment 990 of the inner lining 950, and/or as the bottom opening 310 of the bowl 220. A circumference, diameter or dimensions of the top fitment engaging member 260 may or may not be approximately the same as a circumference, diameter, or dimensions of the opening 130 of the container 120, the fitment 990, and/or the bottom opening 310 of the bowl 220. The top fitment engaging member 260 may be connected with, attached to, and/or otherwise formed with a bottom edge of the bowl 220. The top fitment engaging member 260 may have the same circumference, diameter and/or cross-sectional shape throughout a height of the top fitment engaging member, or the circumference, diameter and/or cross-sectional shape may vary, such as where the top fitment engaging member 260 tapers or has a funnel shape. The top fitment engaging member 260 may have a circumference of various shapes and/or sizes. For example, a circumference of a top fitment engaging member 260 may be circular with a diameter of 1.27 inches. Various other dimensions, shapes, positions, and/or configurations are possible.

The bottom fitment engaging member 270 may be or resemble the top fitment engaging member 260 in shape and/or size. For example, the bottom fitment engaging member 270 may, for example, be cylindrical, ring-shaped, frusto-conical, and/or various other shapes. The bottom fitment engaging member 270 may be hollow and/or may have a hole in it to allow a liquid to flow through it. The bottom fitment engaging member 270 may have various dimensions. For example, where the bottom fitment engaging member 270 is cylindrical, the bottom fitment engaging member 270 may have a height of approximately 0.25 inches, and a diameter of 1.205 inches. In other systems, the bottom fitment engaging member 270 may have a height greater than 0.25 inches or less than 0.25 inches, and/or may have a diameter of greater than 1.205 inches or less than 1.205 inches.

The bottom fitment engaging member 270 may bound and/or create or identify one or more openings and/or a channel. For example, where the bottom fitment engaging member 270 is cylindrical, a channel may be formed inside cylindrical bottom fitment engaging member 270. In some systems, a cross-sectional shape of the bottom fitment engaging member 270 may be the same or a similar shape as the opening 130 of the container 120, the fitment 990 of the inner lining 950, and/or a cross-section of a top portion of the spout 235. A circumference, diameter, or dimensions of the bottom fitment engaging member 270 may or may not be approximately the same as a circumference, diameter, or dimensions of the opening 130 of the container 120, the fitment 990, and/or a top portion of the spout 235. The bottom fitment engaging member 270 may be connected with, attached to, and/or otherwise formed with a top portion of the spout 235. The bottom fitment engaging member 270 may have the same circumference, diameter and/or cross-sectional shape throughout a height of the bottom fitment engaging member 270, or the circumference, diameter and/or cross-sectional shape may vary, such as where the bottom fitment engaging member 270 tapers or has a funnel shape. The bottom fitment engaging member 270 may have a circumference of various shapes and/or sizes. For example, a circumference of a bottom fitment engaging member 270 may be circular with a diameter of 1.2 inches. The circumference of the bottom fitment engaging member 270 may be the same or different in size and/or shape from the circumference of the top fitment engaging member 260. For example, the circumference of the bottom fitment engaging member 270 may be the same shape, but a smaller size, than the circumference of the top fitment engaging member 260. Various other dimensions, shapes, positions, and/or configurations are possible.

A channel, one or more dimensions, and/or a diameter of the cross-section of the bottom fitment engaging member 270 may be smaller than channel, one or more dimensions, and/or a diameter of the cross-section top fitment engaging member 270. In these systems, the filling device 100 may be used with a container 120 with different sized openings 130, and/or including different sized fitment 990. For example, where an opening 130 of the container 120 and/or an opening of a fitment 990 of an inner lining 950 is near or slightly bigger than a diameter or channel of the bottom fitment engaging member 270, the filling device 100 may be inserted into the container 120 until the bottom fitment engaging member 270 fits inside the opening 130 and/or the fitment 990, after which the filling device 100 may be used to fill the container 120. In a different container 120 with an opening 130 and/or fitment 990 that is similar to or bigger than a diameter of the top fitment engaging member 260, the same filling device 100 may be inserted into the different container 120 until the top fitment engaging member 260 is inserted into the opening 130 and/or fitment 990. Where a filling device 100 has a top fitment engaging member 260 with a greater diameter or channel than the bottom fitment engaging member 270, the filling device 100 may be configured so as to be stacked and/or nested with another identical or similar filling device 100. Other configurations are possible.

The top fitment engaging member 260 and the bottom fitment engaging member 270 may be connected to each other, such as with or using a transition component 275, which may also be referred to as a transition zone. The transition component 275 may be hollow and/or may have a hole in it to allow a liquid to flow through it. The transition component 275 may have a generally frusto-conical shape, with a larger opening approximately the same size as a diameter of the top fitment engaging member 260, and a smaller opening approximately the same size as a diameter of the bottom fitment engaging member 270. The transition component 275 may transition a size of an opening through the filling device 100 from a first diameter size equal to a diameter of a channel through the top fitment engaging member 260 to a second diameter size equal to a diameter of a channel through the bottom fitment engaging member 270. The transition component 275 may be rounded and/or smooth. In other systems, the transition component 275 may include a sharp intersection between a portion with a first radius and/or dimensions and a portion with a second radius and/or dimensions. In some configurations and/or in some uses with various containers 120 which may have openings 130 and/or fitment 990 into which the bottom fitment engaging member 270 may fit, the transition component 275 may act as a stopper, preventing the filling device 100 from being inserted into the container 120 beyond the transition component 275. Other configurations are possible.

The filling device 100 may be used, for example, with containers 120 having at least two differently sized openings 130. In one container, for example, an opening 130 and/or fitment 990 may be the same size or slightly larger than a circumference of the bottom fitment engaging member 270. The filling device 100 may be inserted into the container until the bottom fitment engaging member 270 is inside the opening 130 and/or fitment 990. Friction or other similar forces may cause the filling device 100 to engage and/or fit within the opening 130 and/or fitment 990, and/or may prevent the filling device 100 from being inserted any further into the container. The transition component 275 may, in some circumstances, act as a stopper, whereby the filling device 100 cannot be inserted into the first container any further. In a second container, for example, an opening 130 and/or fitment 990 of the inner lining 950 may be the same size or slightly larger than a circumference of the top fitment engaging member 260. The filling device 100 may be inserted into the second container until the top fitment engaging member 260 is inside the opening 130 and/or fitment 990. Friction or other similar forces may cause the filling device 100 to engage and/or fit with the opening 130 and/or fitment 990 of the second container, and/or may prevent the filling device 100 from being inserted any further into the container. In some systems, the bottom edge of the bowl 220 may or may not act as a stopper, preventing the filling device 100 from being inserted further into the container. Various other uses and/or configurations are possible.

More or less fitment engaging members with differing sizes and/or transition components may be used and/or included with the filling device 100. For example, a filling device 100 may have four fitment engaging members with different diameters, each of which may be useful with containers 120 with at least four different sizes of openings 130 and/or fitments 990. Each of the one or more of the fitment engaging members may be attached to each other and/or separated from each other by one or more transition components 275. In other systems, only one or no fitment engaging members may be included. For example, the joining component 230 may be one fitment engaging member, such as the top fitment engaging member 260. Various configurations, combinations, positions, and/or sizes are possible.

The filling device 100 may include a spout 235. The spout 235 may be directly or indirectly connected with the joining component 230 and/or the bowl 220. For example, the spout 235 may be connected to a bottom edge of a bottom fitment engaging member 270 of the joining component 230. Various other configurations are possible.

The spout 235 may be various shapes. For example, the spout 235 may be frusto-conical, frusto-pyramidal, frusto-spherical, cylindrical, may taper, and/or may be various other shapes. For example, the spout 235 may have an upper spout portion 238 which may be generally frusto-conical and attached to a bottom edge of the bottom fitment engaging member 270. The upper spout portion 238 may have a constant cross-sectional shape, or may taper and/or be shaped or act like a funnel. A speed at which a beverage poured into the filling device 100 exits through the bottom of the filling device 100 may be limited by a size and/or cross-section of the upper spout portion 238. A spout 235 may be tapered to accommodate and/or allow one or more filling devices to be stacked together. Other shapes are possible.

The filling device 100 may include a pusher 240. The pusher 240 may be a part of the spout 235, or may be separate. Where the pusher 240 is not part of the spout 235, the spout may only be the upper spout portion 238. Where the pusher 240 is part of the spout 235, the pusher 240 may be attached to, connected with, and/or formed with a bottom edge of the upper spout portion 238 of the spout 235. The pusher 240 may, for example, extend below the spout. Various other configurations are possible.

The pusher 240 may be or resemble a portion of a frusto-conical or cylindrical shape. For example, the pusher 240 may be or resemble a frusto-conical shape with a large cut-out portion removed. The pusher 240 may be or have a curved or rounded shell or wall. In other systems, the pusher 240 of the spout 235 may be or resemble a blade or a finger, which may be semi-cylindrical or semi-frusto-conical, and/or may taper from a bottom of the upper spout portion 238 to the bottom edge 292 of the spout 235. The pusher 240 may include an interior surface 245, which may or may not contact and/or guide a substance inserted into the filling device 100. The pusher 240 may be referred to as a pusher, blade, pusher blade, tip, and/or spout tip.

The pusher 240 may have a rounded, smooth, curved, and/or dull bottom surface. The pusher 240 may, for example, be rounded and/or radiused, which may reduce and/or avoid incidence of tearing an inner lining 950 during insertion into a container 120. Various other configurations are possible.

The pusher 240 may be various heights. For example, in some systems, the pusher 240 may be approximately 2.15 inches, or may be various other heights. A height of a pusher 240 may be increased or decreased to create a larger or smaller void in the inner lining 950, and/or to provide a greater opening through which a beverage inserted into the filling device 100 may exit. A shape of the pusher 240, such as a tapered or half-funnel shape of a pusher 240, may allow for nesting and/or stacking of multiple filling devices 100.

The pusher 240 and/or spout 235 may have an edge 290 which may bound or identify an opening, such as a bottom opening, of the filling device 100, and/or may bound or identify the pusher 240. The edge 290 may create, bound, and/or identify a large cut-out portion of the frusto-conical shape of the spout 235, and/or the finger-shaped pusher 240. The edge 290 may be opposite the bottom fitment engaging member 270 of the filling device 100. The edge 290 may be various other shapes and/or sizes.

The edge 290 may include a top edge 291, a bottom edge 292, two side edges 297 and 298, and/or rounded corner edges 293 and 294. More or less edges or edge portions may be included. The top edge 291 of the edge 290 may be closest to the bottom fitment engaging member 270 and may bound and/or identify a portion of a bottom edge of the upper spout portion 238. The top edge 291 of edge 290 may extend around a portion of the spout 235. For example, the top edge 291 may extend halfway around a bottom edge of the upper spout portion 238.

The edge 290 may include side edges 297 and 298 which may extend along the sides of the pusher 240 down to the rounded corner edges 293 and 294 and to the bottom edge 292. The pusher 240 may have a rounded bottom edge and/or rounded bottom corner edges, such as the bottom bounded by the rounded corner edges 293 and 294 and the bottom edge 292. The rounded corner edges 293 and 294 at the bottom edge of the pusher 240 may help the pusher 240 to move an inner lining away from an opening of a container without tearing the inner lining when a filling device 100 is inserted in the opening 130 of the container 120. Various other configurations and/or arrangements are possible.

The pusher 240 may include one or more ribs or protrusions 280 and 285. The protrusions 280 and 285 may extend outward from an interior surface 245 of the pusher 240. The protrusions 280 and 285 may be positioned near a bottom portion of the pusher 240 and/or may accommodate stacking of multiple filling devices 100. For example, the protrusions 280 and 285 may prevent multiple filling devices 100 from being jammed together and/or getting stuck, such as by acting as a stopper for a bottom edge 292 of a filling device 100 stacked on top of the filling device with the protrusions 280 and 285. For example, a bottom edge 292 of a filling device 100 may rest on a top edge of one or more of the protrusions 280 and 285. The protrusions 280 and 285 may create a space between multiple filling devices 100 and/or side walls or the bowls 220 of multiple filling devices 100 stacked together. The protrusions 280 and 285 and/or the space created by the protrusions 280 and 285 may allow for a user to easily pull apart stacked filling devices 100. Various other uses and/or configurations are possible.

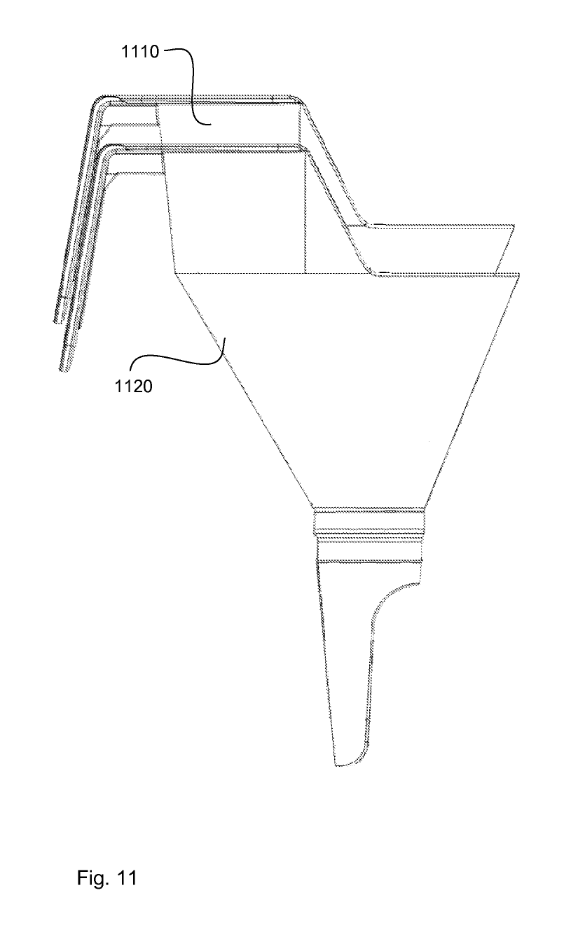

The filling device 100 may include a handle 250. The handle 250 may be various shapes and/or sizes. The handle 250 may, for example, extend outward from a top of the guard 215, such as along a plane of the lip 218, and then may extend downward to form a hand grip. The hand grip of the handle 250 may extend downward at various angles from the plane of the lip 218, such as, for example, at a 100 degree angle. An angle of the hand grip of the handle 250, and/or an angle or configuration of the handle 250, may assist with and/or accommodate nesting or stacking capabilities of the filling device 100. For example, as shown in FIG. 11, where two filling devices 1110 and 1120 are stacked together, the angled handle 250 may allow for the top filling device 1110 to be positioned, and/or may not impede the positioning of the top filling device 1110, nearly entirely inside of the bottom filling device 1120. Other attachments, configurations, and/or angles are possible.

The handle 250 may allow a user to hold the filling device 100 without incurring any damage due to the fluid being poured through the filling device 100. For example, where a hot liquid is being poured into the filling device 100, it may be advantageous for a user to hold the filling device 100 by the handle 250 to avoid burning the user's hand through either spilling or splashing liquid, or through heat transferred through the walls of the filling device 100 during pouring. It may also or alternatively be advantageous for a user to hold the filling device 100 by a handle 250 where a cold liquid is being poured into the filling device 100, such as to avoid contact with a cold temperature and/or filling device, and/or to avoid having a cold liquid splash or splatter on a user's hand.

The guard 215, handle 250, pusher 240, and/or the edge 290 may be positioned in various ways. In some systems, the guard 215 and handle 250 may be positioned and/or aligned on the same side of the filling device 100 as the pusher 240. In these systems, the edge 290 may or may not bound and/or identify an opening in the spout 235 and/or pusher 240 opposite the handle 250 and/or the guard 215. In these systems, it may be advantageous to have the pusher 240 on the same side as the guard 215. As mentioned, a user may use the guard 215 to identify a portion of the bowl 220 that may be a target for pouring a liquid. By positioning the pusher 240 on the same side as the guard 215, a liquid poured by the user may contact with, be diffused by, and/or be evenly distributed by the spout 235 and/or pusher 240. This may aid in a smooth distribution of the liquid into the inner lining 950 of the container 120, and may prevent the liquid from otherwise splattering if it were to hit the inner lining 950 of the container 120 unimpeded by the filling device 100. This may also aid in distributing the substance into the container 120 along the edges of the filling device 100, allowing for a space within a portion of the filling device, such as the center of the filling device 100, through which air may exit the container 120 during filling. In other configurations, the guard 215 may be positioned opposite the pusher 240 or in other positions. Various configurations are possible.

The filling device 100 may have an overall height, such as a height from a top of the guard 215 to a bottom edge 292 of the pusher 240 and/or spout 235. The overall height may be, for example, 7.25 inches, or may be various other heights. The filling device 100 may have an overall width, such as a width measured from the outmost end of the hand grip of the handle 250 horizontally across the filling device 100 to the furthest point on the bowl 220 opposite the handle 250. The overall width may be, for example, 5.34 inches, or may be various other widths. Various other dimensions and/or configurations are possible.

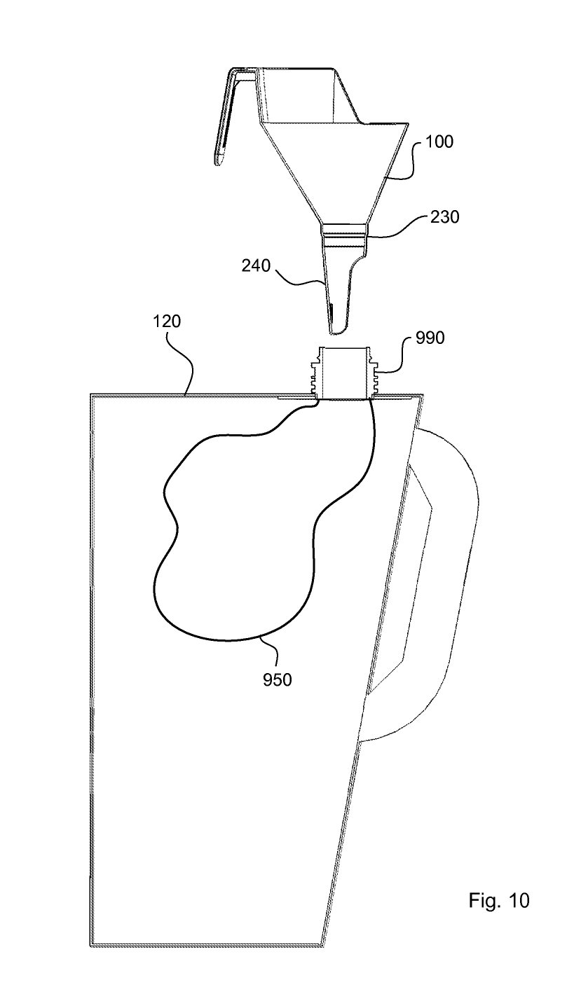

FIG. 9 illustrates one way in which the filling device 100 may be used with the container 120. FIG. 10 illustrates a filling device 100 which may be used to fill a container 120 with an inner lining 950 and a fitment 990. As mentioned, the container 120 may include an outer shell 140, an inner lining 950, an opening 130, a fitment 990, and/or a handle 125.

The outer shell 140 of the container 120 may be various shapes, such as a cube, box-shaped, parallelepiped, oblong, oval, spherical, pyramidal, and/or various other shapes or combinations of shapes. The outer shell 140 of the container 120 may be made of various materials, such as, for example, paperboard, cardboard, metal, wood, plastic, and/or various other materials or combinations of materials. Other configurations are possible.

The container 120 may include an inner lining 950. The inner lining 950 may be made of plastic or various other materials. The inner lining 950 may, for example, be a bag. The inner lining 950 of the container 120 may be impermeable and/or may be used to store a liquid inside of the outer shell 140 of the container 120. The inner lining 950 may hold a liquid or a substance without the liquid or substance leaking from the inner lining 950. The inner lining 950 may also be referred to as a bag or inner liner.

The inner lining 950 may be inside the outer shell 140 of the container 120. The inner lining 950 may be attached and/or connected with the outer shell 140 of the container 120, such as at or near the opening 130. For example, an inner lining 950 may include a fitment 990 which may protrude, extend beyond, fit within, and/or be positioned next to or through a portion of the outer shell 140 of the container 120. The fitment 990 may extend through, or may be the opening 130 of the container 120. An interior of the inner lining 950 may be accessible through the opening 130 and/or the fitment 990 of the container 120.

The fitment 990 may be a continuation of the inner lining 950, and/or may be formed with the inner lining 950. The fitment 990 may bound and/or identify a hole or opening into the inner lining 950. In some systems, the opening of the fitment 990 may be considered the opening 130 of the container. In other systems, the fitment 990 may be distinct from the opening 130, and/or may fit or be positioned within the opening 130 of the container. The fitment 990 may include a cap, cover, or other device which may seal the hole or opening in the fitment 990. In some systems, the cap, cover, and/or sealing device may be positioned on the fitment 990 from an exterior of the outer shell 140 of the container 120. An outer surface of a fitment 990 may have a threading and/or snap functions and features which may be used to secure the cap, cover and/or sealing device to the fitment 990. An inner surface of the fitment 990 may be any shape, such as cylindrical, round, square, oval, oblong, and/or any other shape that an opening 130 may be. An inner surface of the fitment 990 may be smooth, curved, and/or various other textures and/or configurations. Various other fitmet 990 configurations are possible.

The opening 130 and/or circumference of the fitment 990 may be various sizes and/or dimensions. In some containers 120, the opening 130 and/or circumference of the fitment 990 may be circular and/or cylindrical, and may have a diameter of 1.275 inches, or may have a diameter of 1.21 inches. The opening 130 and/or circumference of the fitment 990 may be sealable, such as with a cap or cover, such that contents in the inner lining 950 may not escape or leave the inner lining 950. In systems where the container 120 does not have an inner lining 950, a cap may be attached and/or secured to the opening 130 of the container, where the opening 130 may or may not include a fitment similar to a fitment 990. Various other sizes and/or shapes of an opening 130 are possible.

An opening 130 and/or fitment 990 may be positioned on various parts of the container 120. For example, an opening 130 and/or fitment 990 may be placed on a top or side wall of a container 120. In other configurations, an opening 130 may be placed on a top portion of a container and a bottom portion of a container 120, and each opening may be associated with a different inner lining 950 inside the outer shell 140 of the container. In some configurations, the opening 130 and/or fitment 990 may accommodate an easy tipping and/or pouring of a beverage in the container 120 into glasses and cups. In some configurations, the opening 130 and/or fitment 990 may correspond to a placement of the handle 125, such that a grasping of the handle may facilitate a movement of the container 120 so that a beverage pours out of, or is kept away from, an opening 130.

Some containers 120 may have more than one inner lining 950, fitment 990, and/or opening 130. Other containers 120 may not have an inner lining 950, but may themselves be impermeable and/or resistant to leaks. Various containers 120 may be possible.

In some circumstances, an inner lining 950 may be shrunken and/or rest closely to the opening 130. In these situations, simply pouring a substance into the opening 130 of the container 120 may not readily fill the inner lining 950, as the liquid may gather near the opening 130 and/or may spill out of the opening 130 of the container.

The container 120 may or may not include a handle 125. The handle 125 may be various shapes and may be positioned at various portions of the container 120, such as on a top panel or side panel of the container 120. The handle 125 may allow a user to pick up and carry the container 120, and/or may facilitate a pouring position for the container 120. Various other configurations are possible.

A filling device 100 may be used, for example, to fill the inner lining 950 with a substance, such as a beverage 920. Any cap or covering over the opening 130 and/or fitment 990 may be removed, and the filling device 100 may be inserted into the container 120 through the container opening 130 and/or fitment 990.

The pusher 240 and/or spout 235 of the filling device 100 may be useful in moving the inner lining 950 of the container away from the opening 130, fitment 990, and/or spout 235. A bottom portion of a pusher 240 may have a smaller size than the opening 130 of the container 120, and may be first inserted into the opening 130 and/or fitment 990. The filling device 100 may continue to be pushed and/or slid into the opening 130 of the container and into the interior of the inner lining 950 until most or the entire pusher 240 and/or spout 235 may be inside of the container 120 and/or until the filling device 100 has been inserted a desired distance.

As the filling device 100 is being inserted into the container 120, the pusher 240 may contact the inner lining 950. The pusher 240 may push the inner lining 950 toward an end of the container 120 opposite the opening 130. The pusher 240 may push the inner lining 950 of the container 120 away from the opening of the spout 235, and/or the end of the filling device 100.

The pusher 240 and/or spout 235 may have a rounded bottom surface, such as a bottom surface bounded by the rounded corner edges 293 and 294 and the bottom edge 292. This rounded bottom surface of the pusher 240 and/or spout 235 may contact the inner lining 950, but may be curved or rounded and may not cut, rip, tear, or otherwise puncture the inner lining 950. As such, the pusher 240 may create a space in the inner lining 950 while maintaining the impermeable nature of the inner lining 950.

When inserted, the joining component 230 and/or one of the fitment engaging members 260 or 270 may fit snugly against the opening 130 of the container, and/or against the fitment 990. The joining component 230 and/or fitment engaging members 260 and 270 may engage and/or cooperate with the opening 130 and/or fitment 990, such that the filling device 100 may be stable during pouring. The joining component and/or fitment engaging members 260 and 270 may or may not be tightly fit together. This may be accomplished, such as through a frictional or other force exerted between these components. In some of these systems, no threading or snapping may be necessary. The joining component 230 and/or fitment engaging members 260 and 270 may provide stability during filling by providing a snug fit for the filling device 100 with the container, and may reduce incidences of spillage where a filling device is not fit with a container 120. The pusher 240 may ensure that any inner lining 950 in the container 120 is not directly opposite or in contact with where the fitment engaging members 260 and 270 meet the opening 130.

The inner lining 950 may be separated, opened, enlarged, and/or expanded by the pusher 240 and/or spout 235 when the filling device 100 is inserted into the opening 130 and/or fitment 990 of the inner lining 950 of the container 120. A space, void, or opening in the inner lining 950 may be created and/or enlarged by the pusher 240 when the filling device 100 is inserted into the opening 130 and the inner lining 950 of the container 120. The space created by the pusher 240 and/or spout 235 in the inner lining 950 may allow for a substance, such as beverage 920, to be rapidly poured into the opening 130 and to flow into and/or fill the inner lining 950 of the container 120.

Once a filling device 100 is inserted into the container 120 and/or the joining component 230 is fit with the opening 130 and/or fitment 990 of the container 120, a beverage 920 may be poured from the beverage holder 910. The beverage 920 may be any liquid or fluid, such as coffee, soda, tea, or various other fluids. The beverage holder 910 may, for example, be a brewing pot, a coffee pot, a beverage dispenser, a liquid dispenser, and/or various other beverage holders.

The beverage 920 may be poured and/or otherwise dispensed from the beverage holder 910 into the filling device 100. A user and/or vendor may aim a poured beverage 920 toward a side of the filling device 100 that includes the guard 215 of the filling device 100. The beverage 920 may enter the filling device 100 through the opening 210. The beverage 920 may be funneled and/or otherwise directed by the bowl 220 of the filling device toward the bottom opening 310. The beverage may pass through the bottom opening 310, into and through the top fitment engaging member 260 and the bottom fitment engaging member 270. The beverage 920 may pass through the upper spout portion 238 of the spout 235. The beverage 920 may leave the filling device 100 through a bottom of the upper spout portion 238 and enter the inner lining 950. The beverage 920 may leave the filling device 100 at the bottom of the upper spout portion 238 of the spout 235, and therefore may enter the inner lining 950 a distance above where the inner lining 950 have been pushed by the pusher 240. The pusher 240 may not limit a speed at which a beverage 920 poured into the filling device 100 may exit the filling device 100.

When the beverage holder 910 is empty and/or the inner lining 950 filled to a desired level, the filling device 100 may be removed. Any cap or covering may be replaced over the opening 130, and/or the fitment 990 and inner lining 950 may be sealed so that the beverage 920 in the inner lining may not leak or pour out of the container 120.

A flow of a beverage 920 through into a container 120 may be limited by a size of an opening at a bottom of the filling device 100 and/or by how fast air can escape from the container 120 while a beverage is poured in. The filling device 100 may provide for a rapid flow of substance through the filling device 100 and into the inner lining 950, such as because of the large cut-out portion of and/or opening created in the spout 235 and/or pusher 240. The filling device 100 with the spout 235 and/or pusher 240 may provide advantages over other funnels in that the large opening bounded and/or identified by edge 290 and/or the large cut-out portion of the spout 235 and/or pusher 240 may create a larger opening and/or area through which air and/or a beverage may pass, and may allow for a faster transition of substances through the filling device 100 and into the inner lining 950. The large opening of the spout 235 and/or pusher 240 may advantageously allow for filling of the inner lining 950 with a beverage 920 while at the same time letting air escape the inner lining 950 and exit the container 120.

FIG. 11 illustrates two filling devices 1110 and 1120 which are stacked on top of each other and/or nested together. Filling devices 1110 and 1120 may resemble and/or be constructed in the same manner as filling device 100.

When stacked together, a portion or all of the filling device 1110 may fit and/or rest comfortably inside of the filling device 1120. The filling devices 1110 and 1120 may stack together such that a majority of the top filling device 1110 is positioned within the bottom filling device 1120. For example, the pusher 240, the spout 235, the joining component 230, and a large portion of the bowl 220 of the top filling device 1110 may be bounded and/or partially or completely enclosed by one or more components of the bottom filling device 1120.

The stacking ability of the filling devices 1110 and 1120 may be enabled and/or result from an outwardly angled guard 215, an angled handle 250, a tapered bowl 220, fitment engaging members 260 and 270, and/or a tapering spout 235 and pusher 240. A frusto-conical shaped and/or tapering bowl 220 may produce, create and/or accommodate in a stacking ability of filling devices 1110 and 1120. Filling devices with multiple fitment engaging members, where a top fitment engaging member has a greater circumference, diameter, and/or dimensions may also or alternatively produce, create and/or accommodate a stacking ability of filling devices 1110 and 1120. Filling devices with a joining component 230 which has a greater top opening than a bottom opening may also or alternatively produce, create and/or accommodate a stacking ability of filling devices 1110 and 1120. Filling devices with frusto-conical and/or tapering spout 235, and/or an exposed and/or tapering pusher 240 may also or alternatively produce, create and/or accommodate a stacking ability of filling devices 1110 and 1120. Protrusions 280 and 285 may produce, create, and/or accommodate a stacking ability of filling devices 1110 and 1120. Various other components and/or configurations may produce, create, and/or accommodate a stacking ability of filling devices 1110 and 1120.

In some systems, when the filling devices 1110 and 1120 are stacked, the top of the filling device 1110 may rise above the top of the filling device 1120 by, for example, 1 inch or less. For example, a top filling device 1110 may be nested such that only a top 0.75 inches of the top filling device 1110 may extend over a top edge of the bottom filling device 1120. Other heights and configurations are possible are possible.

While FIG. 11 shows two filling devices 1110 and 1120 stacked together, more filling devices may be stacked on top of, below, or in between the two filling devices 1110 and 1120. For example, one hundred or more filling devices may be stacked on top of each other. Various numbers of filling devices may be stacked and/or nested.

Stacking filling devices may be beneficial for shipping and/or packaging of multiple filling devices. A manufacture may benefit from the stacking ability of the filling devices by being able to condense large orders of filling devices into stacks which may make packaging and shipping more space and time efficient. For example, where a manufacturer wishes to ship one hundred filling devices each with a height of 8 inches, a width from the handle to the front of the bowl of 5 inches, and a width across the bowl of 4 inches, the manufacturer may need to have approximately 100×(8″×5″×4″)=16,000 in³ of space in the shipping vehicle if he were to ship the filling devices individually, such as in individual boxes. However, where each of the filling devices may be stacked within another filling device and extend above a filling device by only one inch, the manufacturer may be able to ship these one hundred filling devices requiring only (8″+99(1″))×5″×4″=2,140 in³ of space in the shipping vehicle. As such, the nesting and/or stacking ability of these filling devices may provide storage and/or shipping efficiency.

The filling device 100 may have a spout 235, pusher 240, and/or bottom opening 310 that may configured and/or large enough that air may escape from the container 120 while a beverage is poured into the filling device 100 at a rapid speed. Other filling devices may be implemented which may have additional or different features from filling device 100 that may aid or assist in allowing air to escape from a container 120.

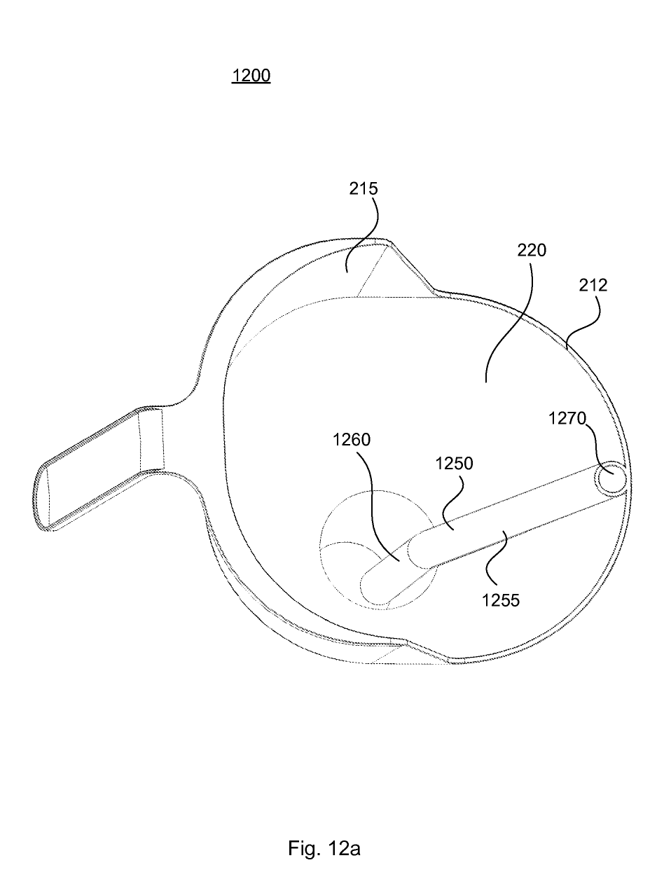

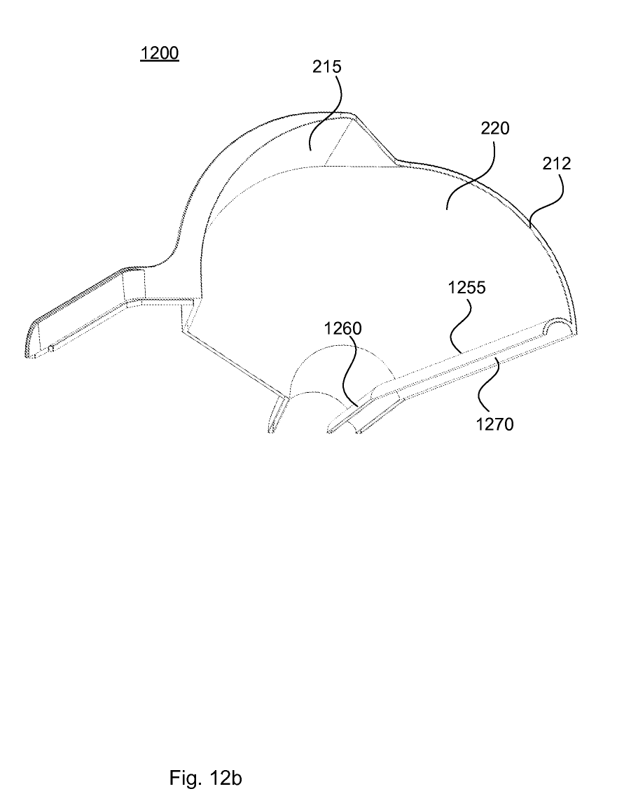

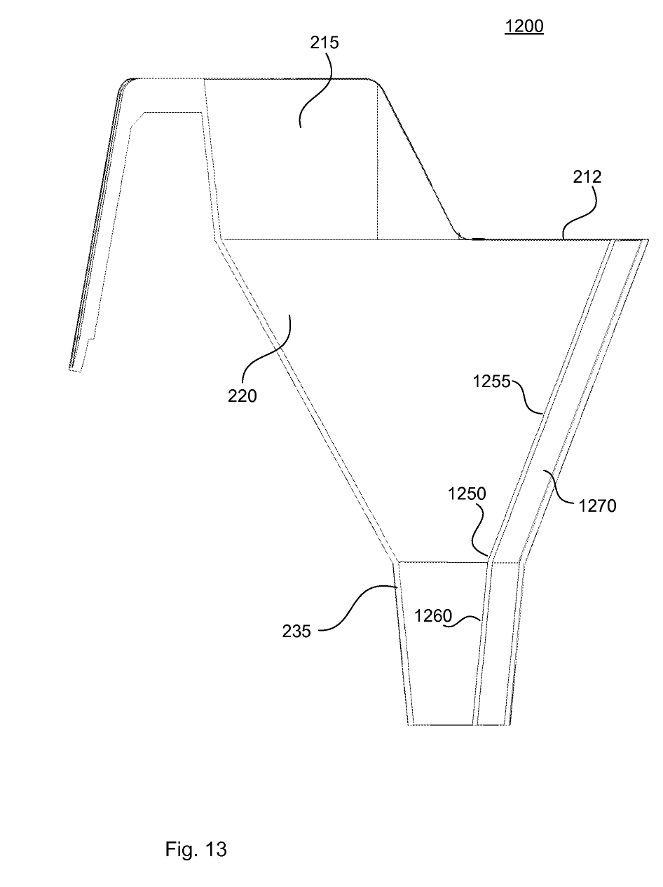

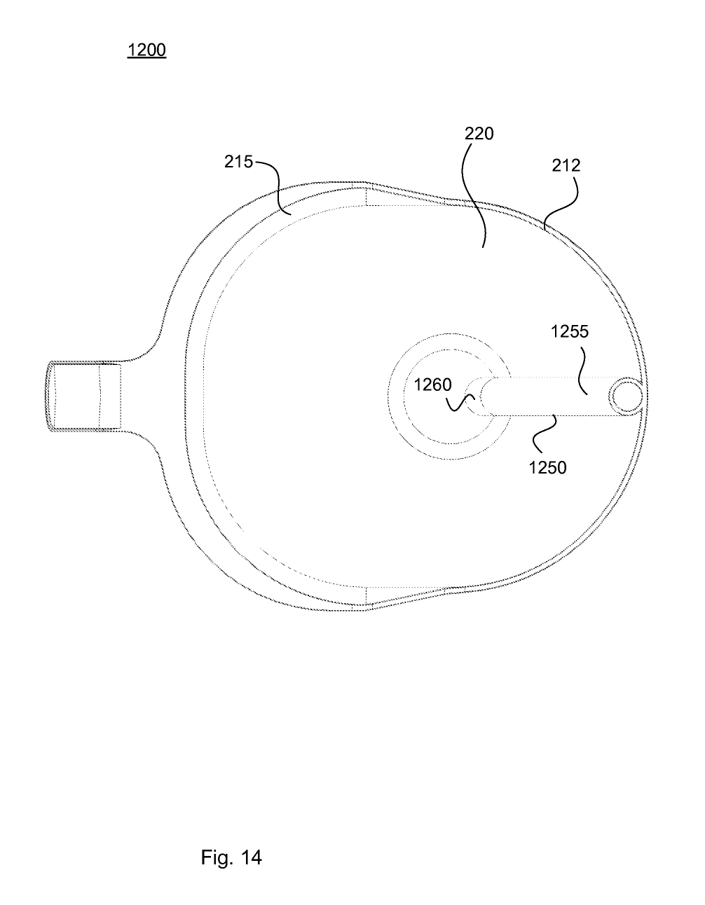

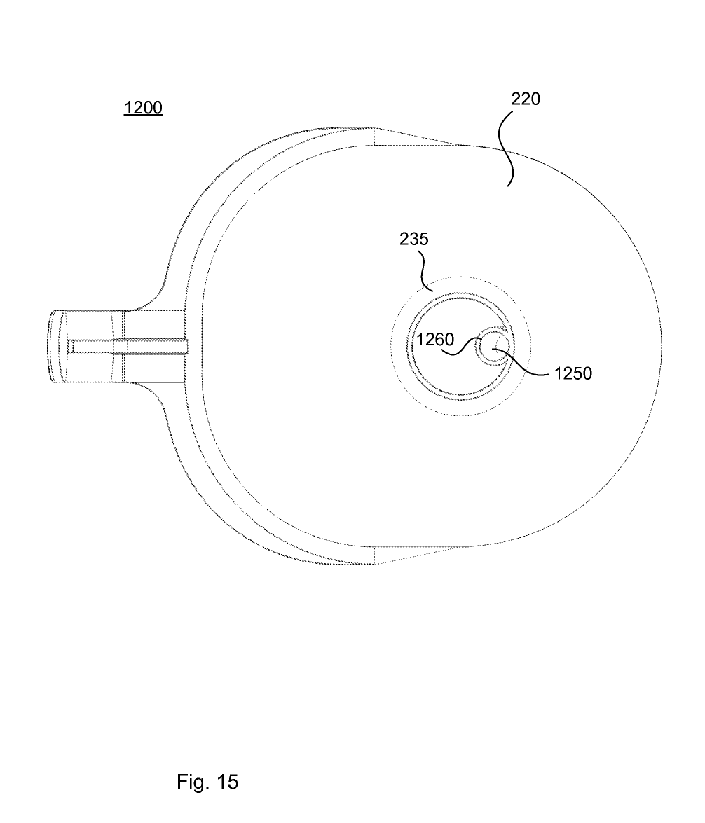

FIG. 12a shows an elevated perspective view of a filling device 1200 that includes an air passage 1250 along an interior of the filling device 1200. FIG. 12b shows a cross-sectional top perspective view of the filling device 1200. FIG. 13 shows a cross-sectional side view of a filling device 1200. FIG. 14 shows a top view of the filling device 1200. FIG. 15 shows a bottom view of the filling device 1200.

The filling device 1200 may be similar to the filling device 100. The filling device 1200 may have one or more of a bowl 220, a guard 215, a handle 250, and/or a spout 235. The filling device 1200 may or may not include a pusher 240. The filling device 1200 may include more or less features.

The filling device 1200 may include an air passage 1250. The air passage 1250 may also be referred to as a vent, channel, straw, straw feature, tunnel, and/or air release member or component. The air passage 1250 may be added to the filling device 1200 before or after the filling device 1200 is formed, or may be molded or formed when the filling device 1200 is created. Various other ways of forming the air passage 1250 may be possible.

The air passage 1250 may, for example, resemble a straw. The air passage 1250 may be various shapes and have various cross-sections. For example, the air passage 1250 may resemble a cylinder with a circular cross-section. Alternatively, the air passage 1250 may be rectangular, triangular, and/or various other shapes, and have a cross-section which may be oval, oblong, rectangular, triangular, and/or various other shapes. The air passage 1250 may bound or identify a channel and/or opening 1270. The channel or opening 1270 may have an area which may be the same and/or different throughout the cross-section of the air passage 1250. Air may flow through the channel or opening 1270 of the air passage 1250, such as when a fluid is poured through the filling device 1200 into a container 120. Various other shapes are possible.

The air passage 1250 may extend from a top edge 212 of the bowl 220 of the filling device 1200 to a bottom of the spout 235 of the filling device 1200. For example, the air passage 1250 may include a top air passage portion 1255 that may be positioned on an interior portion of the bowl 220 and/or may run parallel to a portion of a side wall of the bowl 220, and a bottom air passage portion 1260 that may be positioned on and/or run parallel to an interior portion of the spout 235. Alternatively, the air passage 1250 may extend from a point higher or lower than the top edge 212 of the bowl 220, to a point higher or lower than the bottom edge of the spout 235. In some systems, the air passage 1250 may not rise or be positioned above a top edge 212 of the bowl 220. Various other configurations are possible.

The air passage 1250 may be positioned on a side of the bowl 220 opposite the guard 215 and/or handle 250. This configuration may be advantageous in that it may be easier to mold the filling device 1200. This configuration may also be advantageous in that a user may aim and/or pour a beverage to an opposite side of the bowl 220, and not into the air passage 1250. Alternatively, the air passage 1250 may be positioned in other places on the filling device 1200. For example, the air passage 1250 may be positioned on an exterior surface of the filling device 1200.

Air may flow out from a container 120 while a beverage is poured into and through a filling device 1200. The air passage 1250 may be advantageous in that a beverage may be poured into and through a filling device 1200 at a rapid speed and/or through an entire opening 310 of the bottom of the filling device 1200 while air inside the container 120 may still be able to escape an interior of the container 120 through the air passage 1250. Various other configurations and/or users may be possible.

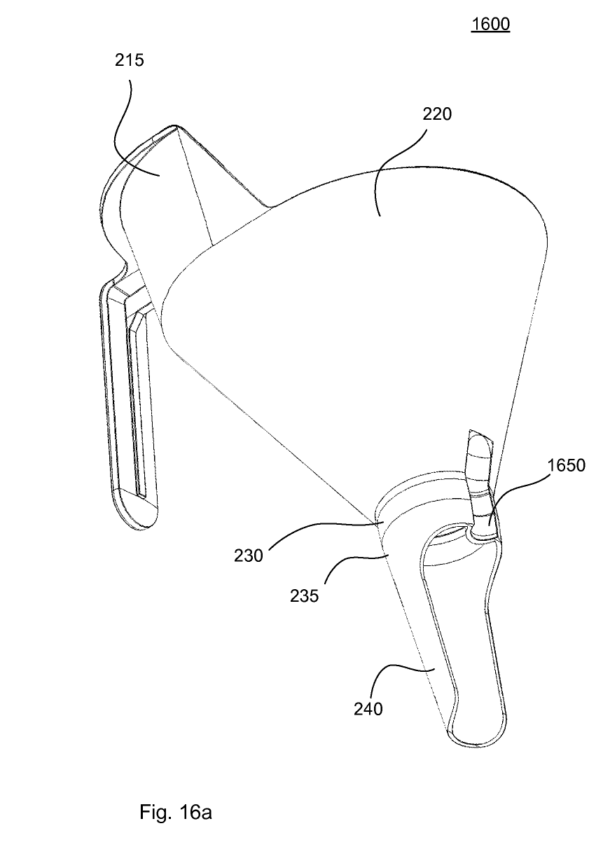

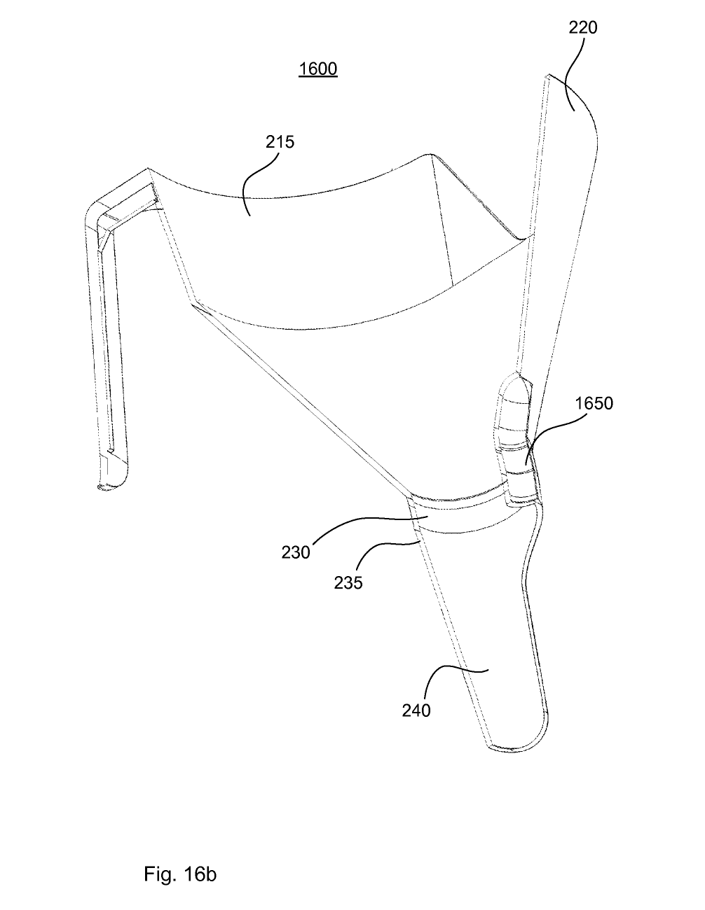

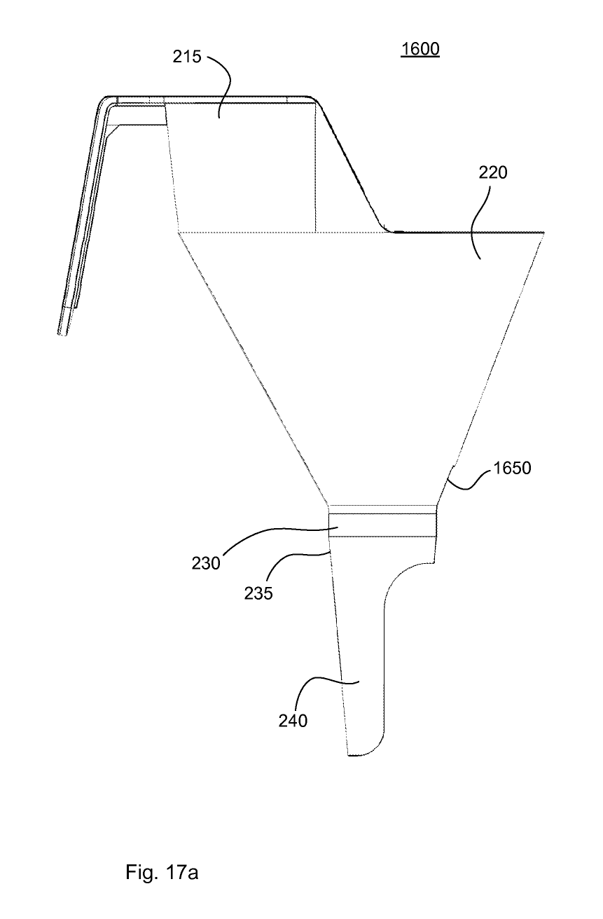

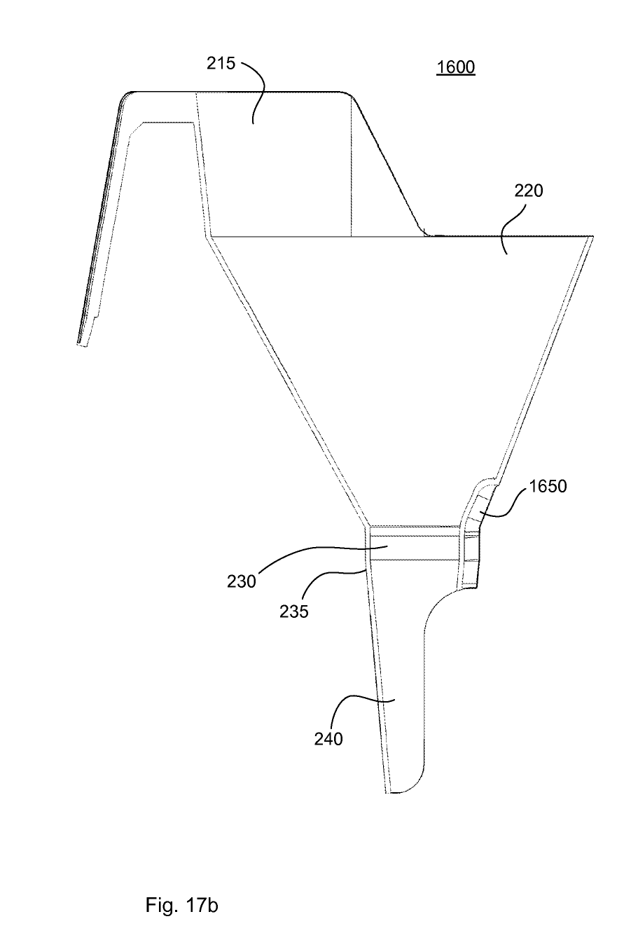

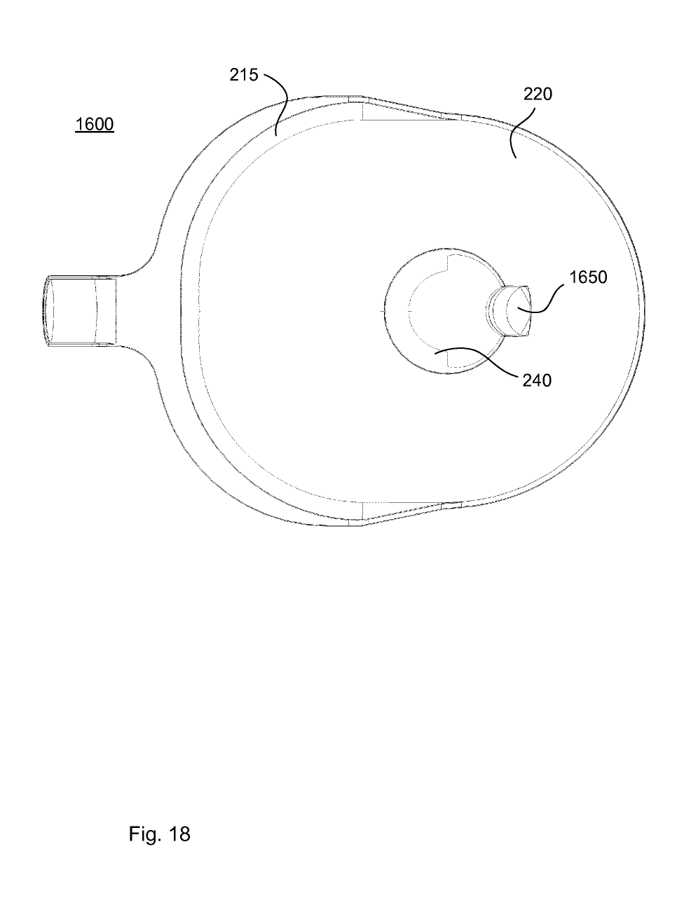

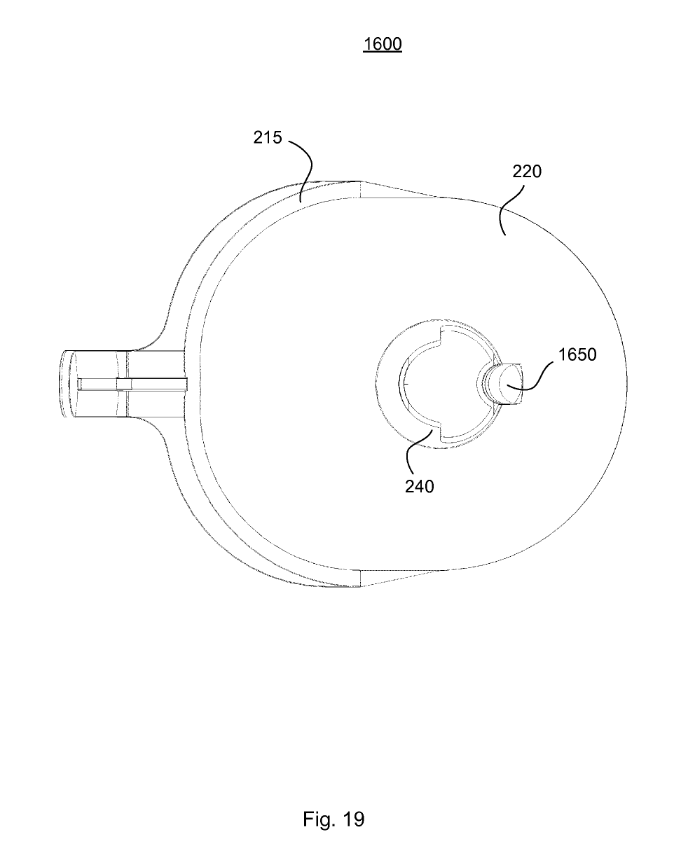

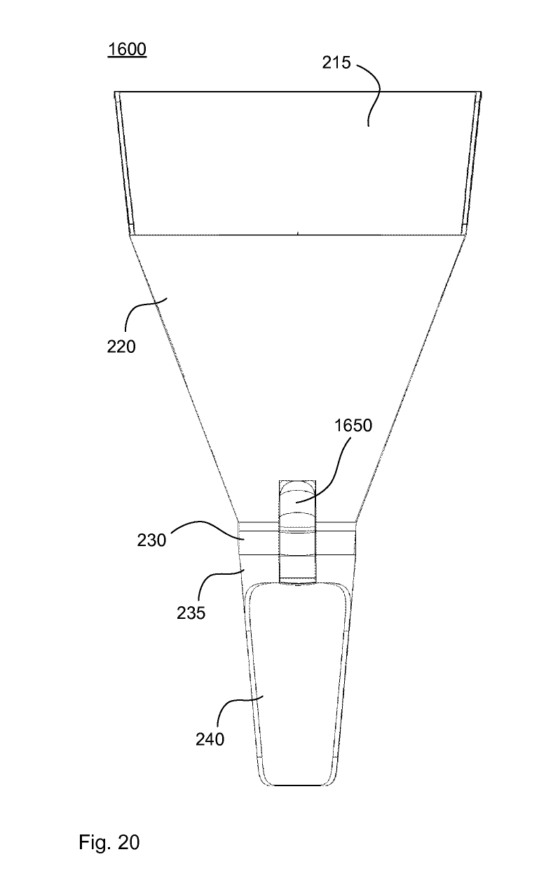

FIG. 16a shows a side perspective view of a filling device 1600. FIG. 16b shows a cross-sectional side perspective view of the filling device 1600. FIG. 17a shows a side view of the filling device 1600. FIG. 17b shows a cross-sectional side view of the filling device 1600. FIG. 18 shows a top view of the filling device 1600. FIG. 19 shows a bottom view of the filling device 1600. FIG. 20 shows a front view of the filling device 1600.

The filling device 1600 may be similar to the filling device 100. The filling device 1600 may have one or more of a bowl 220, a guard 215, a handle 250, a spout 235, and/or a pusher 240. The filling device 1600 may include more or less features.

The filling device 1600 may include an indentation 1650, which may also be referred to as a channel, gap, opening, cutout, pushed-in surface, and/or cutout region. The indentation 1650 may be added to the filling device 1600 after the filling device 1600 is formed, or may be molded or formed when the filling device 1600 is created. Various other ways of forming the indentation 1650 may be possible.

The indentation 1650 may, for example, be an indentation in part of the filling device 1600. The indentation 1650 may be various shapes and have various cross-sections. For example, the indentation 1650 may resemble a semi-cylindrical indentation, or may be semi- or completely cylindrical, rectangular, triangular, and/or various other shapes, and have a cross-section which may be oval, oblong, rectangular, triangular, and/or various other shapes. The indentation 1650 may be bound or identified by an indentation wall which may create a partially exposed channel and/or opening. The partially exposed opening or channel may have an area which may be the same and/or different throughout the cross-section of the indentation 1650. Various other shapes are possible.

The indentation 1650 may extend from a bottom edge of the spout 235 of the filling device 1600 to a middle portion of the bowl 220 of the filling device 1600. Alternatively, the indentation 1650 may extend from a point higher or lower than a bottom edge of the spout 235, to a point higher or lower than the middle portion of the bowl 220. Various other configurations are possible.

The indentation 1650 may be positioned on an exterior side of the filling device 1600 opposite the guard 215 and/or handle 250. Alternatively, the indentation 1650 may be positioned in other places on the filling device 1600. For example, the indentation 1650 may be positioned on an interior surface of the filling device 1600.

The indentation 1650 may form and/or bound an air gap between the filling device 1600 and a fitment 990 and/or opening 130 of a container 120 when a portion of the filling device 1600 is inserted into the container 120. Air may flow out from a container 120 while a beverage is poured into and through a filling device 1600, such as between the filling device 1600 and the container 120 and/or fitment 990 through the indentation 1650. The indentation 1650 may be advantageous in that a beverage may be poured into and through a filling device 1600 at a rapid speed and/or through an entire opening 310 of the bottom of the filling device 1600 while air inside the container 120 may be able to escape an interior of the container 120 through the indentation 1650. Air may be able to escape without traveling through a bowl 220 of the filling device 1600, thereby reducing incidence of a user clogging the path for the air to escape. Various other configurations and/or uses are possible.

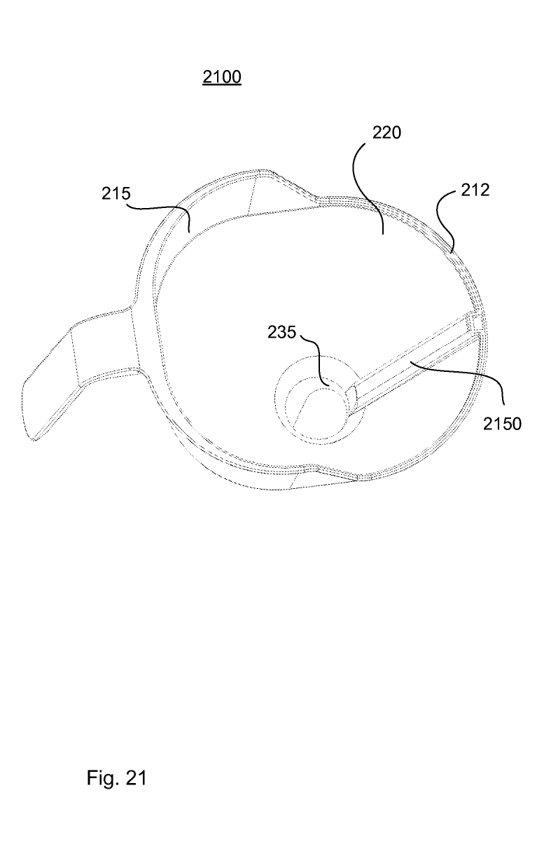

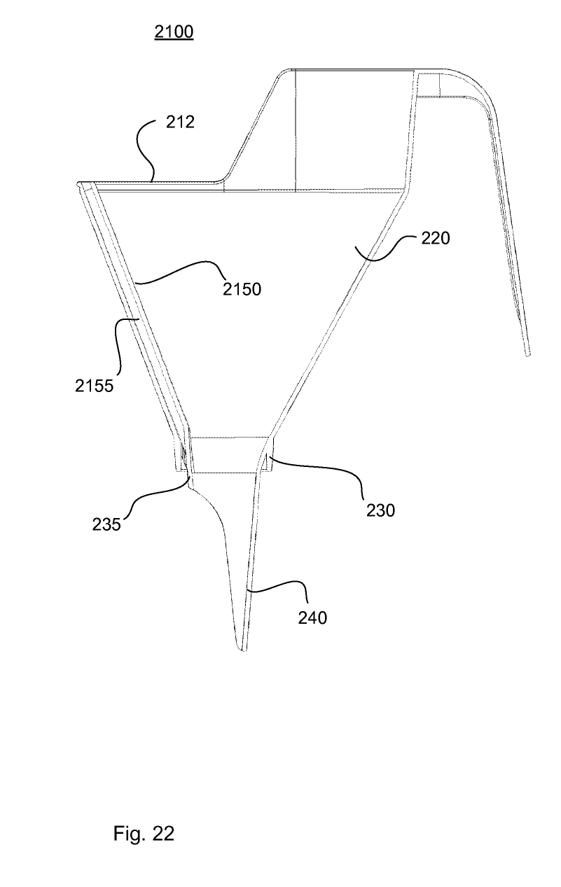

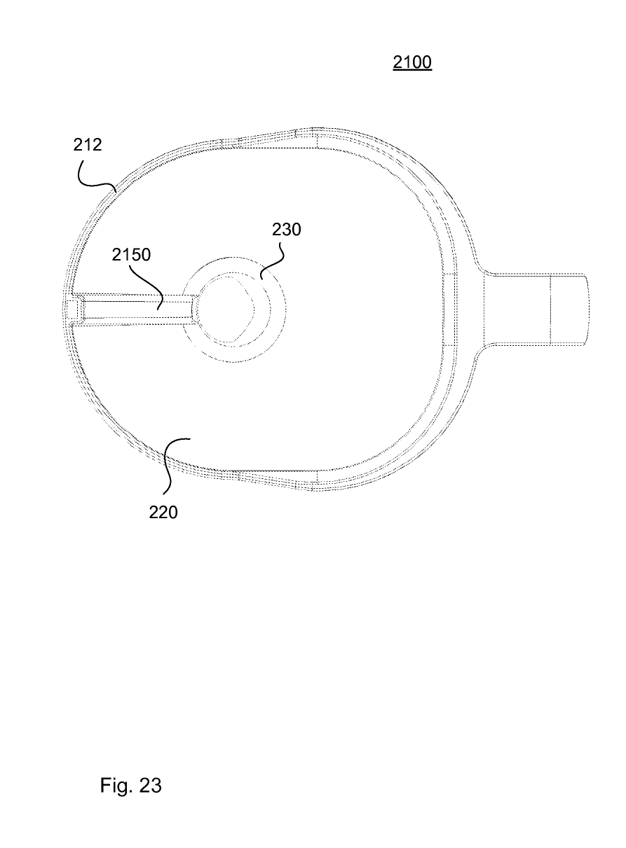

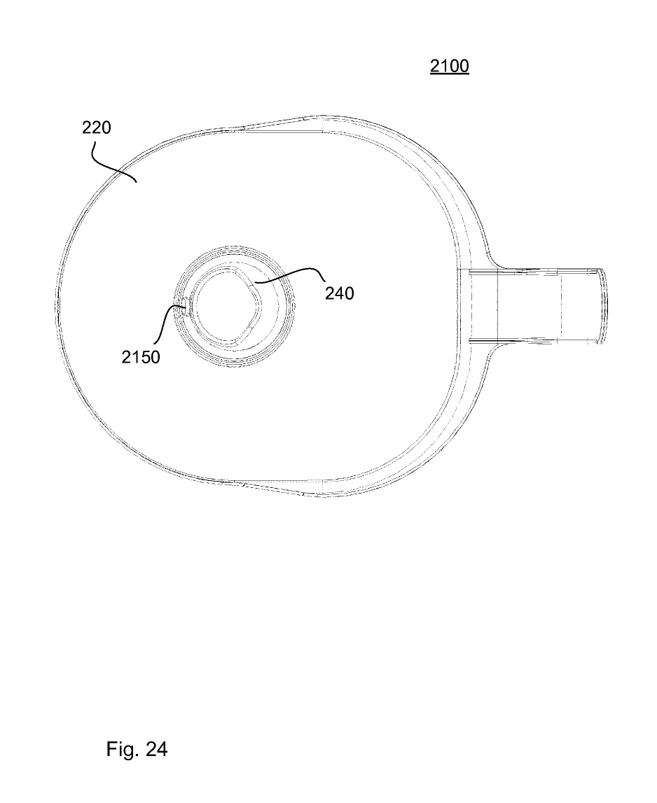

FIG. 21 shows a top perspective view of a filling device 2100 that includes an air passage 2150. FIG. 22 shows a cross-sectional side view of the filling device 2100. FIG. 23 shows a top view of the filling device 2100. FIG. 24 shows a bottom view of the filling device 2100.

The filling device 2100 may be similar to the filling device 100, and/or may resemble the filling device 1200. The filling device 2100 may have one or more of a bowl 220, a guard 215, a handle 250, a spout 235, and/or a pusher 240. The filling device 2100 may include more or less features.

The filling device 2100 may include an air passage 2150. The air passage 2150 may also be referred to as a vent, channel, straw, straw feature, flattened straw, tunnel, and/or air release member or component. The air passage 2150 may be added to the filling device 2100 before or after the filling device 2100 is formed, or may be molded or formed when the filling device 2100 is created. In some systems, the air passage 2150 may be formed using a rod during the molding process, such that the air passage 2150 is molded around the rod. The air passage 2150 may be flattened and/or straight, such that after the filling device 2100 is molded, the rod may be pulled out of the filling device without damaging the molded filling device 2100. Various other ways of forming the air passage 2150 may be possible.

The air passage 2150 may, for example, resemble a wide and shallow rectangular straw, and/or may resemble the air passage 1250 of the filling device 1200. The air passage 2150 may be various shapes and have various cross-sections. For example, the air passage 2150 may resemble a rectangular channel with a square or rectangular cross-section. Alternatively, the air passage 2150 may be circular, cylindrical, triangular, and/or various other shapes, and have a cross-section which may be oval, oblong, circular, triangular, and/or various other shapes. The air passage 2150 may bound or identify a channel and/or opening, such as channel 2155. The opening or channel 2155 may have an area which may be the same and/or different throughout the cross-section of the air passage 2150. Air may flow through the opening or channel 2155 of the air passage 2150, such as when a fluid is poured through the filling device 2100 into a container 120. Various other shapes are possible.

The filling device 2100 may include joining component 230. The joining component 230 may be shaped and/or function similarly to the joining component 230 of the filling device 100. The joining component 230 of the filling device 2100 may be attached to the bowl 220 in various ways, such as how the joining component 230 and the bowl 220 of the filling device 100 are attached. In filling device 2100, a top edge of the spout 235 may also be attached and/or connected to a top or upper part of the joining component 230. This may be different than filling device 100. Various other configurations are possible.

The channel 2155 formed by the air passage 2150 and an air gap between the joining component 230 and the spout 235, or an interior portion of the filling device 2100, may extend from a top edge 212 of the bowl 220 of the filling device 1200 to a bottom end of the joining component 230 of the filling device 2100. For example, the air passage 2150 may be straight and may be positioned on an interior portion of the bowl 220, and/or may form a portion of the air channel 2155. The air passage 2150 may run parallel to a portion of a side wall of the bowl 220. A joining component 230 may be included with the filling device 2100. The joining component 230 may overhang and/or overlap with a portion or all of the spout 235. The joining component 230 of the filling device 2100 may surround and/or form an air channel or air gap between a spout 235, or an outward-facing interior surface of the filling device 2100, and an interior surface of the joining component 230. The air gap may intersect and/or connect with the portion of the channel 2155 formed by the air passage 2150, extending the channel 2155 from a top edge 212 of the bowl 220 of the filling device 2100 to a bottom edge of the joining component 230. The channel 2155 may extend to and/or into the air gap between the interior surface of the filling device 2100 and the exterior of the joining component 230, such that the air passage 2150 may extend into and/or past a fitment 990 when the filling device 2100 is inserted into a container 120. As such, in these systems, air from the container 120 may pass through an outer edge of the spout 235 into the air gap formed between the joining component 230 and the spout 235, up the channel 2155 through the air passage 2150 and out the top of the filling device 2100. Alternatively, the air passage 2150 may extend from a point higher or lower than the top edge 212 of the bowl 220, to a point higher or lower than the bottom edge of the joining component 230. Various other configurations are possible.

The air passage 2150 may be positioned on a side of the bowl 220 opposite the guard 215 and/or handle 250. This configuration may be advantageous in that it may be easier to mold the filling device 2100. This configuration may also be advantageous in that a user may aim and/or pour a beverage to an opposite side of the bowl 220, and not into the air passage 2150. Alternatively, the air passage 2150 may be positioned in other places on the filling device 2100. For example, the air passage 2150 may be positioned on an exterior surface of the filling device 2100.

Air may flow out from a container 120 while a beverage is poured into and through a filling device 2100. The air passage 2150 may be advantageous in that a beverage may be poured into and through a filling device 2100 at a rapid speed and/or through an entire opening 310 of the bottom of the filling device 2100 while air inside the container 120 may still be able to escape an interior of the container 120 through the air passage 2150. A wide and shallow rectangular air passage 2150 may be beneficial as this may allow multiple filling devices 2100 to be stacked on top of each other. Various other configurations and/or users may be possible.

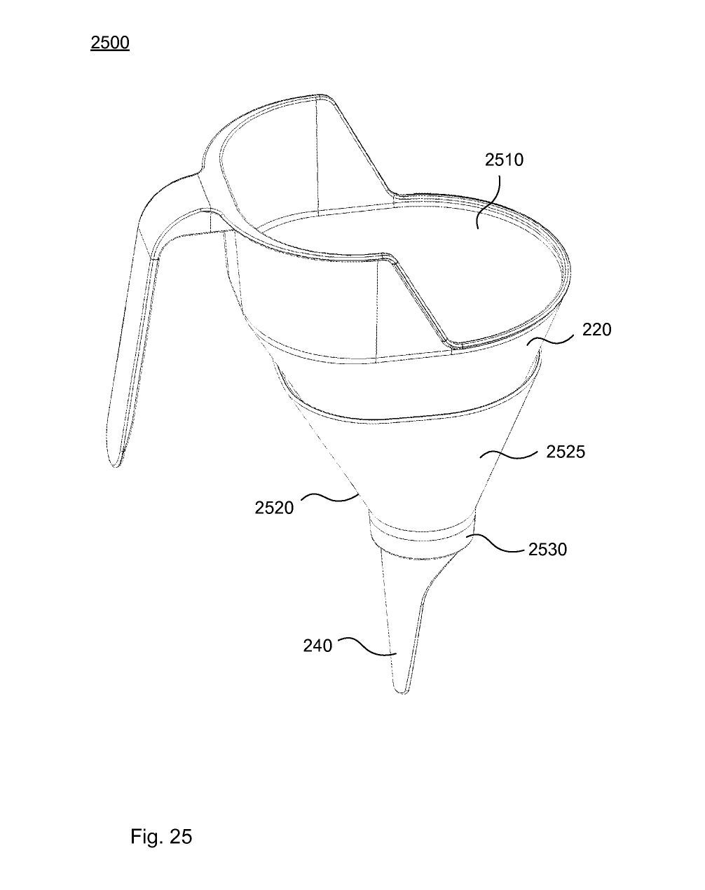

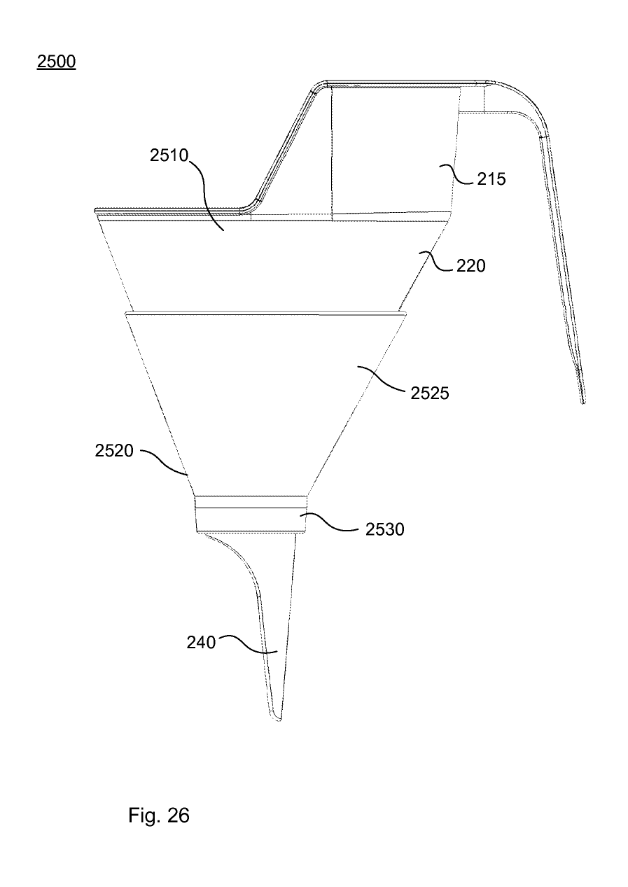

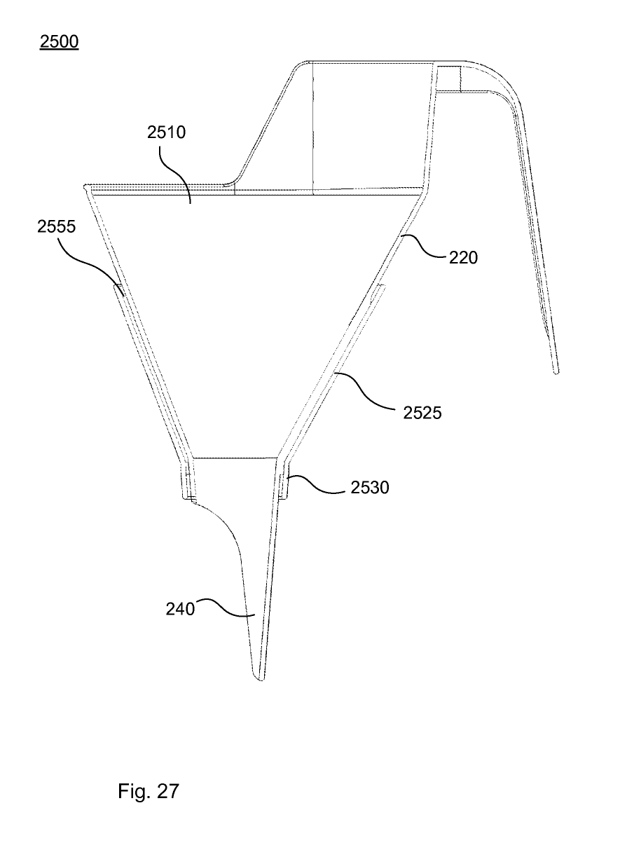

FIG. 25 shows a side perspective view of a filling device 2500. FIG. 26 shows a side view of the filling device 2500. FIG. 27 shows a cross-sectional side view of the filling device 2500.

The filling device 2500 may be similar to the filling device 100. The filling device 2500 may have one or more of a bowl 220, a guard 215, a handle 250, a spout 235, and/or a pusher 240. The filling device 2500 may include more or less features.

The filling device 2500 may have an inner filling device portion 2510 with an additional bowl section 2520 attached to and/or formed with an exterior of the inner filling device portion 2510. The inner filling device portion 2510 may resemble a filling device 100, and/or may have different features. The additional bowl section 2520 may also be referred to as an outer shell, an outer bowl, a bowl-in-bowl structure, a double-bowl, and/or various other names. The bowl section 2520 may be added to the filling device 2500 after the filling device 2500 is formed, or may be molded or formed when the filling device 2500 is created. Various other ways of forming the indentation bowl section 2520 may be possible.

In some systems, the filling device 2500 may resemble filling device 100, with the additional bowl section 2520 added to an exterior of the filling device 100. The bowl section 2520 may include an upper funnel portion 2525, and a lower fitment engaging member 2530, which may be joined, attached to, and/or formed with the upper funnel portion 2525 in various way, such as in ways similar to how the bowl 220 and the joining component 230 of the filling device 100 are joined or attached.

The upper funnel portion 2525 may resemble the bowl 220 of the filling device 100 in that the upper funnel portion 2525 may be frusto-conical and/or various other shapes. The upper funnel portion 2525 may have an outer wall which may be angled. In some systems, the upper funnel portion 2525 may be angled the same or nearly the same as the bowl 220 of the filling device 2500.

The joining component 2530 may resemble and/or be constructed in a similar way as the joining component 230 of the filling device 100. The joining component 2530 may include one or more fitment engaging members and/or transition components.

The bowl section 2520 may be attached to an outer portion of an inner filling device portion 2510. For example, the bowl section 2520 may be molded with the inner filling device portion 2510, or may be added after the creation of the inner filling device portion 2510. For example, the inner filling device portion 2510 may be slid in and through the bowl section 2520. Various other ways of attaching these components are possible. The bowl section 2520 may be attached and/or connected to the inner filling device portion 2510, such as at a back side of the filling device 2500 below the guard and handle of the filling device 2500. The bowl section 2520 may surround a portion or all of the bowl, joining component, and/or spout of the inner filling device portion 2510.

An air gap 2555 may be formed between the bowl section 2520 and the inner filling device 2510. The air gap 2555 may extend around part or most of a circumference of the bowl 220 of the inner filling device 2510, and/or around part or most of a circumference of a joining component 230 of the inner filling device 2510. Air may flow out from a container 120 while a beverage is poured into and through a filling device 2500. The air gap 2555 may be advantageous in that a beverage may be poured into and through a filling device 2100 at a rapid speed and/or through an entire opening 310 of the bottom of the filling device 2500 while air inside the container 120 may still be able to escape an interior of the container 120 through the air gap 2555. Various other configurations and/or users may be possible.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A filling device for directing a flow of a substance into a container, the filling device comprising:
a bowl;
a spout connected with the bowl; and
a pusher connected with the spout to extend below the spout, the pusher having rounded bottom corner edges and being configured to move an inner lining away from an opening of the container without tearing the inner lining when the filling device is inserted in the opening.

2. The filling device of claim 1, wherein the pusher includes a semi-frusto-conical shape.

3. The filling device of claim 1, wherein the spout is tapered to allow filling devices to be stacked.

4. The filling device of claim 3, further comprising a rib protruding from an interior wall of the pusher to prevent filling devices from becoming stuck together when stacked.

5. The filling device of claim 1, further comprising a guard connected with a top edge of the bowl.

6. The filling device of claim 5, wherein the guard includes a flat lip parallel with a top edge of the bowl.

7. The filling device of claim 5, wherein the guard and the pusher are positioned on the same side of the filling device.

8. The filling device of claim 5, further comprising a handle attached to the guard.

9. A filling device for directing a flow of a substance into a container, the filling device comprising:
a bowl;
a first fitment engaging member connected with the bowl, the first fitment engaging member having a first circumference;
a second fitment engaging member connected with the first fitment engaging member and having a second circumference, wherein the second circumference is different than the first circumference; and
a spout connected with the second fitment engaging member.

10. The filling device of claim 9, wherein the first fitment engaging member and the second fitment engaging member include a cylindrical shape.

11. The filling device of claim 10, wherein a diameter of the first fitment engaging member is greater than a diameter of the second fitment engaging member.

12. The filling device of claim 9, wherein the first fitment engaging member is configured to snugly fit within a first container opening, and wherein the second fitment engaging member is configured to snugly fit within a second container opening different than the first container opening.

13. The filling device of claim 9, further comprising a transition component positioned between the first fitment engaging member and the second fitment engaging member.

14. The filling device of claim 9, further comprising a guard attached to a top edge of the bowl, the guard having a flat lip parallel to a top edge of the bowl.

15. The filling device of claim 9, further comprising a handle.

16. The filling device of claim 9, further comprising a pusher below the spout, the pusher having rounded corner edges.

17. A filling device for directing a flow of a substance into a container, the filling device comprising:
a bowl;
a fitment engaging member connected with the bowl; and
a spout below the fitment engaging member and including a curved pusher blade having a rounded bottom edge, the curved pusher blade being configured to push an inner lining away from an opening of the container without tearing the inner lining when the filling device is inserted in the opening.

18. The filling device of claim 17, wherein the filling device is configured to be stacked on top of a second filling device.

19. The filling device of claim 18, wherein the spout is tapered to allow for a portion of the spout to be positioned within a second spout of the second filling device.

20. The filling device of claim 17, wherein the spout is tapered and a circumference of the fitment engaging member is greater than a circumference of the spout to allow for filling devices to be nested.
